(19) United States
(12) Patent Application Publication
(10) Pub. No.: US 2024/0323729 A1
(43) Pub. Date: Sep. 26, 2024

(54) MEASURING UE CLI MEASUREMENT TIMING ADJUSTMENT

(71) Applicant: QUALCOMM Incorporated, San Diego, CA (US)

(72) Inventors: Qian ZHANG, Basking Ridge, NJ (US); Muhammad Sayed Khairy ABDELGHAFFAR, San Jose, CA (US); Yan ZHOU, San Diego, CA (US)

(21) Appl. No.: 18/188,394

(22) Filed: Mar. 22, 2023

(51) Int. Cl. H04W 24/10; H04B 17/345; H04W 72/232

(52) U.S. Cl. CPC H04W 24/10; H04B 17/345; H04W 72/232

(57) ABSTRACT

A network node (first cell) may identify a configuration associated with one or more resources for an L1/L2 CLI measurement associated with a CLI between a first UE and a second UE. The network node (first cell) may transmit, for the first UE, the configuration associated with the L1/L2 CLI measurement via an RRC message or a DCI message. Based on the configuration, the first UE may identify reception timing for an L1/L2 CLI measurement associated with a CLI between the first UE and a second UE. The first UE may perform the L1/L2 CLI measurement associated with the CLI between the first UE and the second UE based on the identified reception timing.

### TECHNICAL FIELD

The present disclosure relates generally to communication systems, and more particularly, to measurement and reporting of cross-link interference (CLI) in a wireless communication system.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a first user equipment (UE). The apparatus may identify reception timing for a layer 1 (L1)/layer 2 (L2) cross-link interference (CLI) measurement associated with a CLI between the first UE and a second UE. The apparatus may perform the L1/L2 CLI measurement associated with the CLI between the first UE and the second UE based on the identified reception timing.

In an aspect of the disclosure, a method, a computer-readable medium, and an apparatus are provided. The apparatus may be a network node. The apparatus may identify a configuration associated with one or more resources for an L1/L2 CLI measurement associated with a CLI between a first UE and a second UE. The apparatus may transmit, for the first UE, the configuration associated with the one or more resources for the L1/L2 CLI measurement via a radio resource control (RRC) message or a downlink control information (DCI) message, wherein the L1/L2 CLI measurement is based on the transmitted configuration.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIGS. 4A, 4B, 4C, and 4D illustrate various modes of full duplex communication FIG. 5 illustrates examples of in-band full-duplex (IBFD) and sub-band frequency divisional duplex resources.

FIG. 6A illustrates a time and frequency resource diagram for sub-band full duplex (SBFD) communication.

FIG. 6B illustrates an example of various types of interference that may be experienced by a device communicating in a full-duplex or SBFD mode.

FIG. 6C illustrates an example of a network node that uses different portions of an antenna panel for SBFD communication.

FIG. 7A illustrates an example of a first cell and a second cell communicating based on a sub-band non-overlapping full-duplex communication.

FIG. 7B illustrates an example of a first cell and a second cell communicating based on a partial or full overlapping full-duplex communication.

FIG. 8 is a diagram illustrating example uplink/downlink timing at both base station and UE sides.

FIG. 9 is a diagram illustrating example L1/L2 UE-to-UE CLI measurement according to one or more aspects.

FIG. 10 is a diagram illustrating example L1/L2 measurement of intra-cell inter-UE CLI according to one or more aspects.

FIG. 11 is a diagram of a communication flow of a method of wireless communication.

FIG. 12 is a diagram of a communication flow of a method of wireless communication.

FIG. 13 is a flowchart of a method of wireless communication.

FIG. 14 is a flowchart of a method of wireless communication.

FIG. 15 is a flowchart of a method of wireless communication.

FIG. 16 is a flowchart of a method of wireless communication.

FIG. 17 is a diagram illustrating an example of a hardware implementation for an example apparatus and/or network entity.

FIG. 18 is a diagram illustrating an example of a hardware implementation for an example network entity.

### DETAILED DESCRIPTION

L1 and/or L2 (L1/L2) UE-to-UE (i.e., inter-UE) CLI measurement may be associated with advantages compared to the layer 3 (L3) inter-UE CLI measurement. A measuring UE and a transmitting UE may be involved in the L1/L2 inter-UE CLI measurement. To perform the L1/L2 inter-UE CLI measurement (and especially to measure the CLI-reference signal received power (CLI-RSRP)), the measuring UE may adjust the reception timing of the measuring UE such that the reception timing of the measuring UE may coincide with the arrival timing of the signal associated with the CLI measurement (e.g., a CLI reference signal (RS)) from the transmitting UE. Therefore, techniques for determining the amount of timing adjustment at the measuring UE may be desired.

In some examples, a network node (first cell) may identify a configuration associated with one or more resources for an L1/L2 CLI measurement associated with a CLI between a first UE and a second UE. The network node (first cell) may transmit, for the first UE, the configuration associated with the one or more resources for the L1/L2 CLI measurement via an RRC message or a DCI message. Based on the configuration, the first UE may identify reception timing for an L1/L2 CLI measurement associated with a CLI between the first UE and a second UE. The first UE may perform the L1/L2 CLI measurement associated with the CLI between the first UE and the second UE based on the identified reception timing.

Particular aspects of the subject matter described in this disclosure can be implemented to realize one or more of the following potential advantages. In some examples, based on the described techniques, the L1/L2 inter-UE CLI measurement may be performed.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

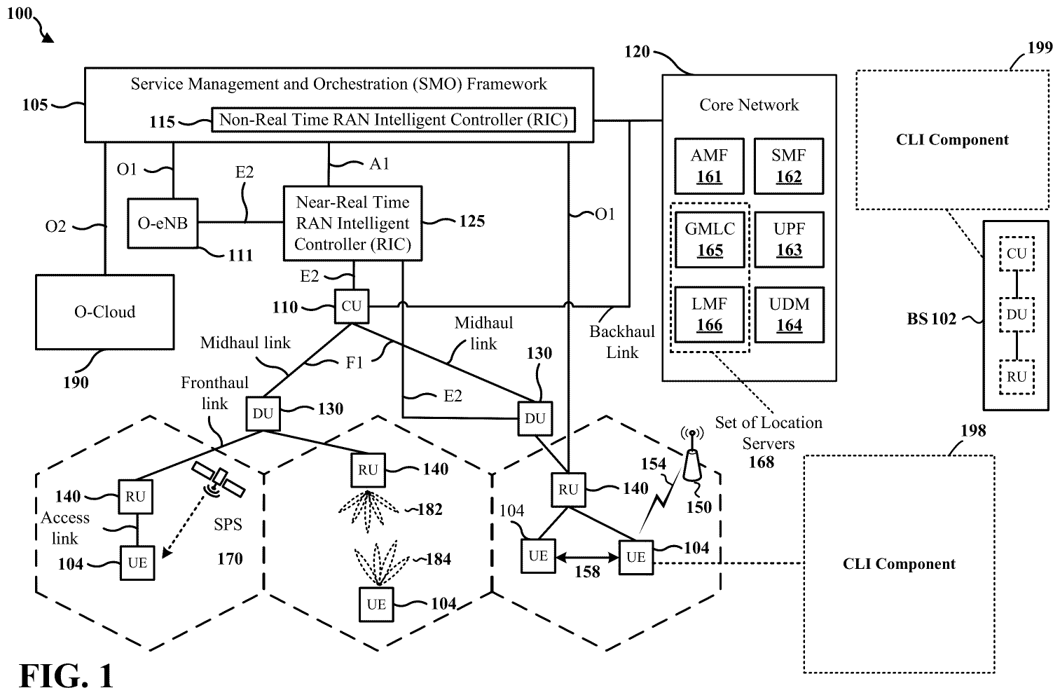

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHZ (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHZ-7.125 GHZ) and FR2 (24.25 GHZ-52.6 GHz). Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” (mmW) band in documents and articles, despite being different from the extremely high frequency (EHF) band (30 GHZ-300 GHZ) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHZ-71 GHZ), FR4 (71 GHz-114.25 GHZ), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have a CLI component 198 that may be configured to identify reception timing for an L1/L2 CLI measurement associated with a CLI between the first UE and a second UE. The CLI component 198 may be configured to perform the L1/L2 CLI measurement associated with the CLI between the first UE and the second UE based on the identified reception timing. In certain aspects, the base station 102 may have a CLI component 199 that may be configured to identify a configuration associated with one or more resources for an L1/L2 CLI measurement associated with a CLI between a first UE and a second UE. The CLI component 199 may be configured to transmit, for the first UE, the configuration associated with the one or more resources for the L1/L2 CLI measurement via an RRC message or a DCI message. The L1/L2 CLI measurement may be based on the transmitted configuration. Accordingly, based on the described techniques, the reception timing at the measuring UE may be adjusted based on an identified amount of timing adjustment. The L1/L2 inter-UE CLI measurement may be performed based on the adjusted reception timing at the measuring UE.

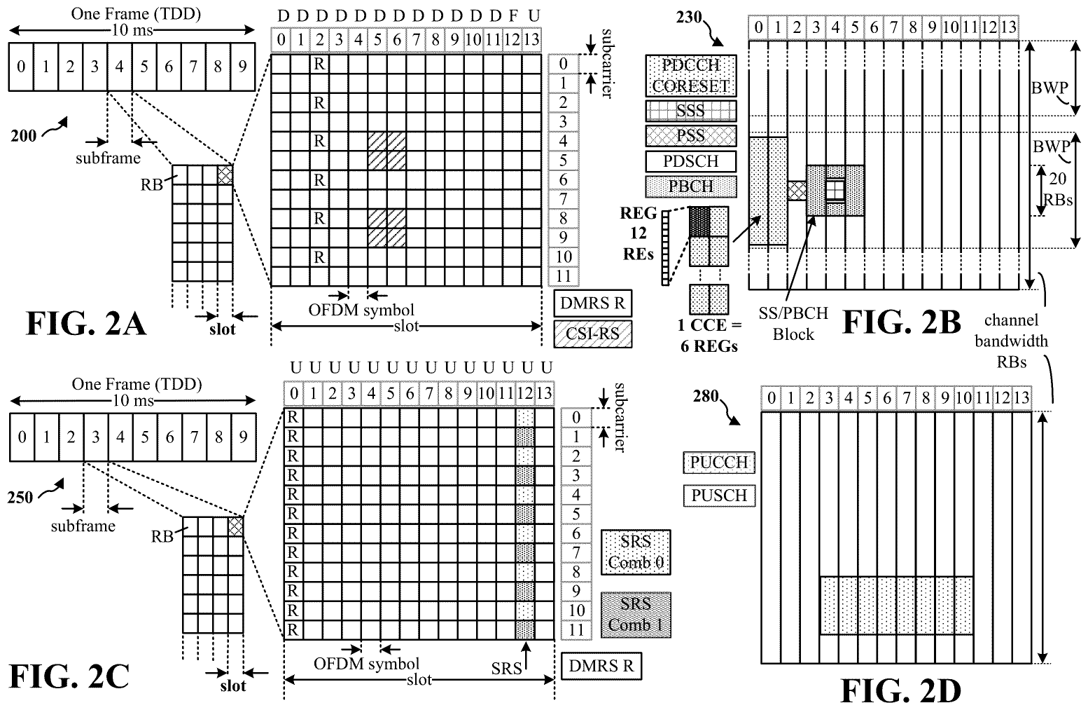

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 24 slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

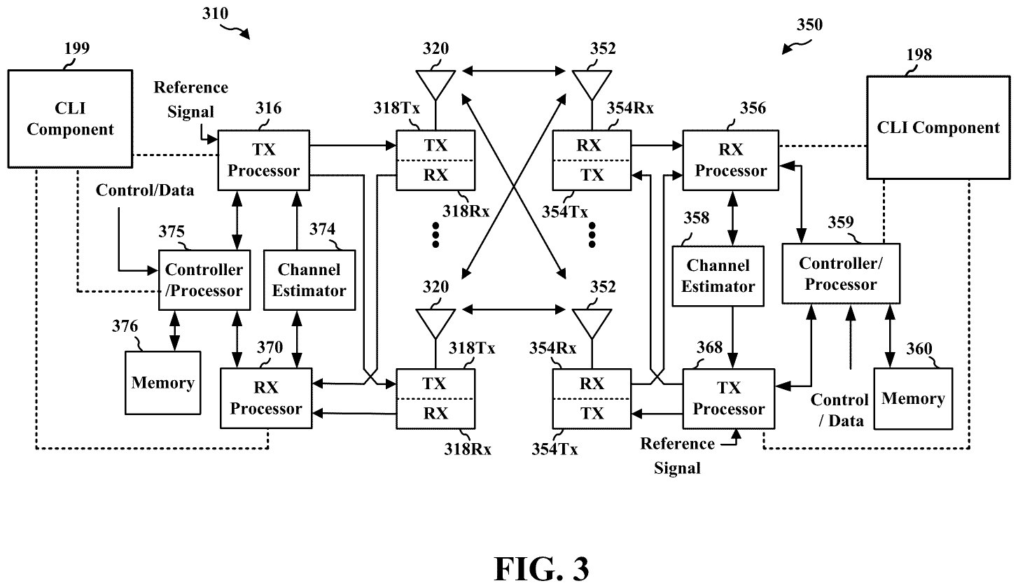

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet t reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the CLI component 198 of FIG. 1.

At least one of the TX processor 316, the RX processor 370, and the controller/processor 375 may be configured to perform aspects in connection with the CLI component 199 of FIG. 1.

Existing L3-based CLI framework may have limited flexibility and a greater latency. In particular, the L3-based CLI reporting may be carried out on the PUSCH and may be collected by the CU first before being communicated to the DU. This may introduce latency to the CLI report availability to the DU (e.g., there may be a latency before the CLI report is available to the DU). On the other hand, L1- or L2-based CLI reporting may not suffer from the increased latency. In addition, the L3-based CLI reporting may be based on periodic CLI measurement resources with L3 filtering. This configuration may not be suitable for enabling fast beam selection in response to the interference variation as compared to L1-based beam selection. Furthermore, for the L3-based CLI reporting, RRC reconfiguration, which may introduce a latency in the order of tens of milliseconds, may be needed to update the configuration of the CLI measurement resource. Accordingly, compared with L3-based CLI reporting that may have limited flexibility and slow adaptability, an L1/L2-based CLI report may be obtained by the DU with a much lower latency. As a result, the L1/L2-based CLI report may better reflect the current CLI. In addition, an L1-based CLI report may be sent on-demand to facilitate fast CLI mitigation.

Wireless communication systems may be configured to share available system resources and provide various telecommunication services (e.g., telephony, video, data, messaging, broadcasts, etc.) based on multiple-access technologies that support communication with multiple users. Full duplex operation, in which a wireless device exchanges uplink and downlink communication that overlaps in time, may enable more efficient use of the wireless spectrum. Full duplex operation may include simultaneous transmission and reception in the same frequency range. In some examples, the frequency range may be an mmW frequency range, e.g., frequency range 2 (FR2). In some examples, the frequency range may be a sub-6 GHz frequency range, e.g., frequency range 1 (FR1). Full duplex communication may reduce latency. For example, full duplex operation may enable a UE to receive a downlink signal in an uplink-only slot, which can reduce the latency for the downlink communication. Full duplex communication may improve spectrum efficiency, e.g., spectrum efficiency per cell or per UE. Full duplex communication may enable more efficient use of wireless resources.

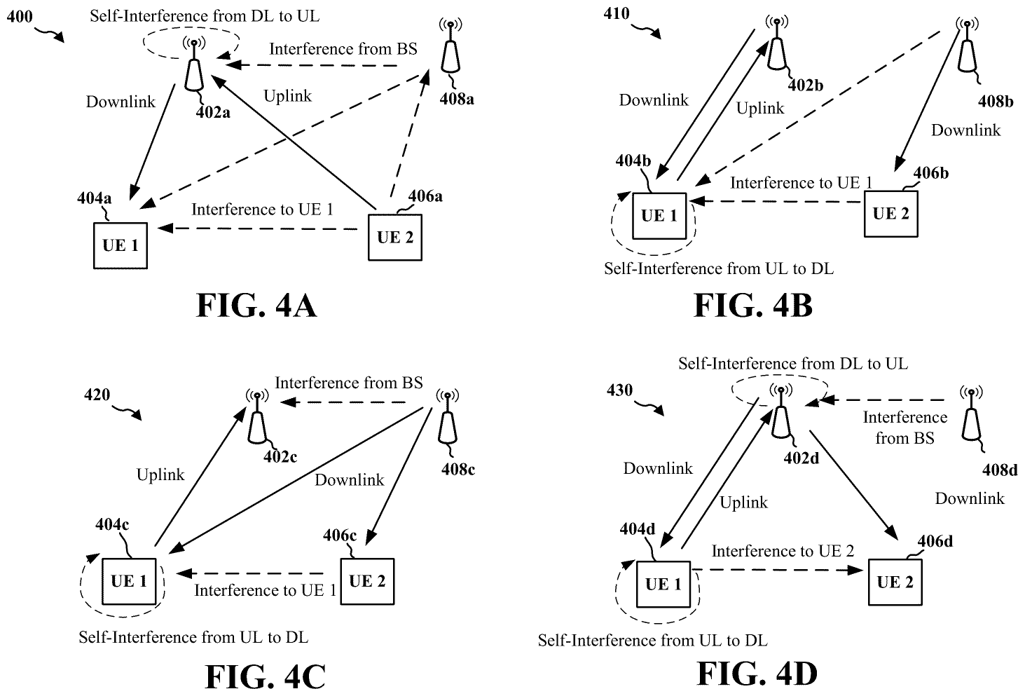

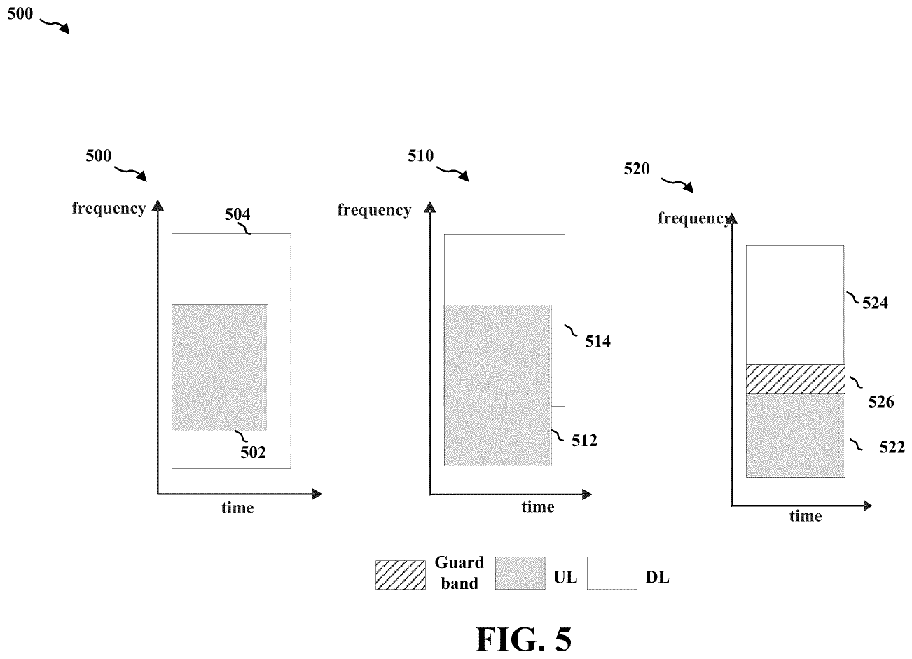

FIGS. 4A, 4B, 4C, and 4D illustrate various modes of full duplex communication. Full duplex communication supports the transmission and reception of information over the same frequency band in a manner that overlaps in time. In this manner, spectral efficiency may be improved with respect to the spectral efficiency of half-duplex communication, which supports the transmission or reception of information in one direction at a time without overlapping uplink and downlink communication. Due to the simultaneous Tx/Rx nature of full duplex communication, a UE or a base station may experience self-interference caused by signal leakage from its local transmitter to its local receiver. In addition, the UE or base station may also experience interference from other devices, such as transmissions from a second UE or a second base station. Such interference (e.g., self-interference or interference caused by other devices) may impact the quality of the communication or even lead to a loss of information.

FIG. 4A shows the first example of full duplex communication 400 in which a first base station 402a is in full duplex communication with a first UE 404a and a second UE 406a. The first UE 404a and the second UE 406a may be configured for half-duplex communication or full-duplex communication. FIG. 4A illustrates the first UE 404a performing downlink reception, and the second UE 406a performing uplink transmission. The second UE 406a may transmit a first uplink signal to the first base station 402a as well as to other base stations, such as a second base station 408a in proximity to the second UE 406a. The first base station 402a transmits a downlink signal to the first UE 404a concurrently (e.g., overlapping at least partially in time) with receiving the uplink signal from the second UE 406a. The base station 402a may experience self-interference at its receiving antenna that is receiving the uplink signal from UE 406a, the self-interference being due to reception of at least part of the downlink signal transmitted to the UE 404a. The base station 402a may experience additional interference due to signals from the second base station 408a. Interference may also occur at the first UE 404a based on signals from the second base station 408a as well as from uplink signals from the second UE 406a.

FIG. 4B shows the second example of full-duplex communication 410 in which a first base station 402b is in full-duplex communication with a first UE 404b. In this example, the UE 404b is also operating in a full-duplex mode. The first base station 402b and the UE 404b receive and transmit communication that overlaps in time and is in the same frequency band. The base station and the UE may each experience self-interference, due to a transmitted signal from the device leaking to (e.g., being received by) a receiver at the same device. The first UE 404b may experience additional interference based on one or more signals emitted from a second UE 406b and/or a second base station 408b in proximity to the first UE 404b.

FIG. 4C shows the third example of full-duplex communication 420 in which a first UE 404c transmits and receives full-duplex communication with a first base station 402c and a second base station 408c. The first base station 402c and the second base station 408c may serve as multiple transmission and reception points (multi-TRPs) for UL and DL communication with the UE 404c. The second base station 408c may also exchange communication with a second UE 406c. In FIG. 4C, the first UE 404c may transmit an uplink signal to the first base station 402c that overlaps in time with receiving a downlink signal from the second base station 408c. The first UE 404c may experience self-interference as a result of receiving at least a portion of the first signal when receiving the second signal, e.g., the UE's uplink signal to the base station 402c may leak to (e.g., be received by) the UE's receiver when the UE is attempting to receive the signal from the other base station 408c. The first UE 404c may experience additional interference from the second UE 406c.

FIG. 4D shows the fourth example of full-duplex communication 430 in which a first base station 402d employs full-duplex communication with a first UE 404d, and transmits downlink communication to a second UE 406d. In this example, the first UE 404d is operating in a full-duplex mode, and the second UE 406d is operating in a half-duplex mode. The first base station 402d and the first UE 404d receive and transmit communication that overlaps in time and is in the same frequency band. The base station 402d and the first UE 404d may each experience self-interference, due to a transmitted signal from the corresponding device leaking to (e.g., being received by) a receiver at the same device. The base station 402d may further experience cross link interference due to a signal transmitted by the base station 408d. The second UE 406d may experience cross-link interference from the uplink transmission of the first UE 404d when receiving downlink communication from the base station 402d.

Full duplex communication may be in the same frequency band. The uplink and downlink communication may be in different frequency sub-bands, in the same frequency sub-band, or in partially overlapping frequency sub-bands. FIG. 5 illustrates a first example 500 and a second example 510 of in-band full-duplex (IBFD) resources and a third example 520 of sub-band full-duplex (SBFD) resources. In IBFD, signals may be transmitted and received in overlapping times and overlapping in frequency. As shown in the first example 500, a time and a frequency allocation of transmission resources 502 may fully overlap with a time and a frequency allocation of reception resources 504. In the second example 510, a time and a frequency allocation of transmission resources 512 may partially overlap with a time and a frequency of allocation of reception resources 514.

IBFD is in contrast to sub-band FDD, where transmission and reception resources may overlap in time using different frequencies, as shown in the third example 520. In the third example 520, the UL, the transmission resources 522 are separated from the reception resources 524 by a guard band 526. The guard band may be frequency resources, or a gap in frequency resources, provided between the transmission resources 522 and the reception resources 524. Separating the transmission frequency resources and the reception frequency resources with a guard band may help to reduce self-interference. Transmission resources and reception resources that are immediately adjacent to each other may be considered as having a guard band width of 0. As an output signal from a wireless device may extend outside the transmission resources, the guard band may reduce interference experienced by the wireless device. Sub-band FDD may also be referred to as “flexible duplex”.

If the full-duplex operation is for a UE or a device implementing UE functionality, the transmission resources 502, 512, and 522 may correspond to uplink resources, and the reception resources 504, 514, and 524 may correspond to downlink resources. Alternatively, if the full-duplex operation is for a base station or a device implementing base station functionality, the transmission resources 502, 512, and 522 may correspond to downlink resources, and the reception resources 504, 514, and 524 may correspond to uplink resources.

SBFD supports simultaneous Tx/Rx of DL/UL on a sub-band basis. SBFD may increase the UL duty cycle, leading to latency reduction and improvement in UL coverage. For example, under SBFD, a UL signal may be transmitted in DL slots or flexible slots, and a DL signal may be received in UL slots, leading to latency savings. SBFD may enhance the system capacity, resource utilization, spectrum efficiency, and enable flexible and dynamic UL/DL resource adaption according to UL/DL traffic in a robust manner.

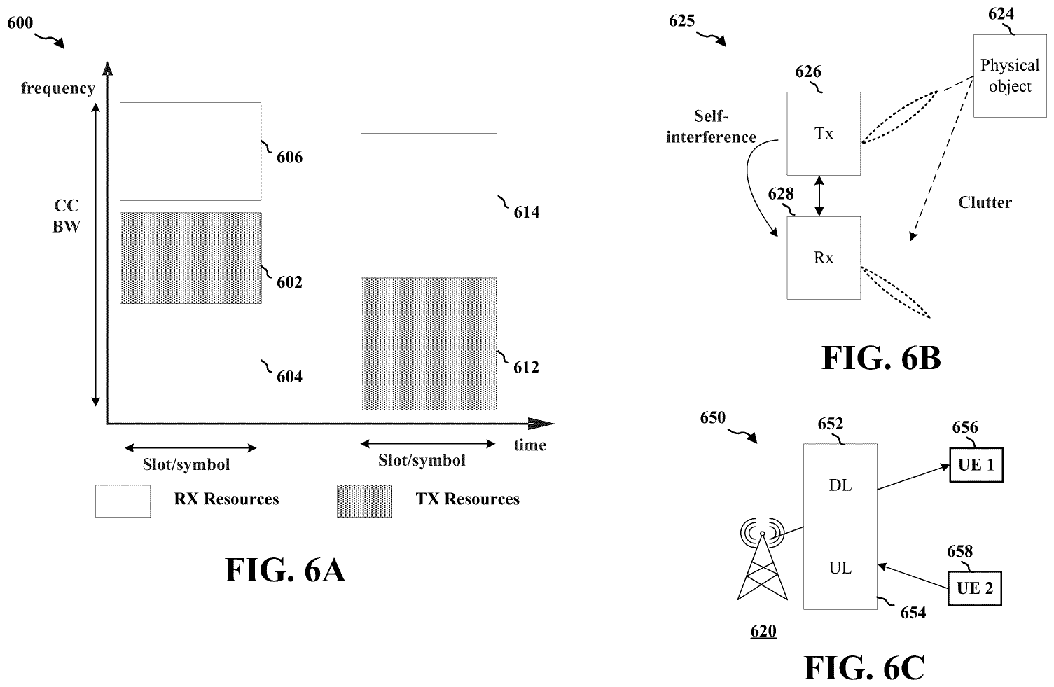

FIG. 6A is a time and frequency diagram 600 illustrating different allocations for SBFD communication. In some aspects, a slot or symbol for SBFD communication may include a contiguous set of frequency resources for transmission 614 (e.g., such as downlink transmission from a base station) and a contiguous set of frequency resources for reception 612 (e.g., such as uplink reception by a base station). In other aspects, the slot or symbol for SBFD communication may include non-contiguous resources for transmission 604 and 606 (e.g., downlink resources for transmission by a base station) and resources for reception 602. Although the example is given for non-contiguous downlink resources, in some aspects, the non-contiguous resources may be for uplink communication. SBFD resources may be provided in a TDD carrier or for an intra-band carrier aggregation (CA). The use of the SBFD allocation of resources can increase the uplink duty cycle leading to a reduction in latency because a UE may transmit uplink signals in an uplink sub-band of a downlink slot or flexible slot. Likewise, a UE may receive a downlink signal in a downlink sub-band in an uplink slot. SBFD operation may improve uplink coverage, improve system capacity, improve resource utilization, and/or improve spectrum efficiency. SBFD operation may enable flexible and dynamic uplink and downlink resource adaptation according to uplink and downlink traffic in a robust manner.

FIG. 6B is a diagram 625 illustrating that a device having a transmitter 626 that transmits a signal on a directional beam may cause interference to the device's receiver 628 as clutter based on a reflection from a physical object 624. The receiver 628 may also receive self-interference by receiving at least a portion of the signal directly from the transmitter 626.

FIG. 6C illustrates a diagram 650 showing a network node 620 having an antenna panel with a portion 652 of the panel used for downlink transmission to a first UE 656 and a second portion 654 of the panel used for uplink reception from a second UE 658.

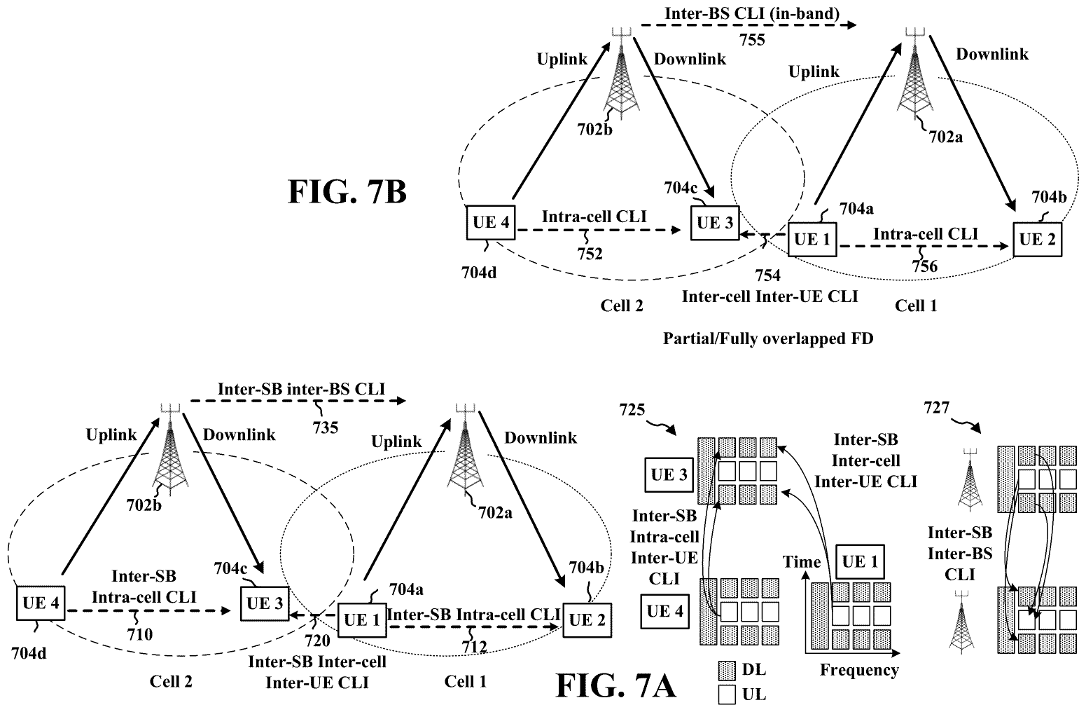

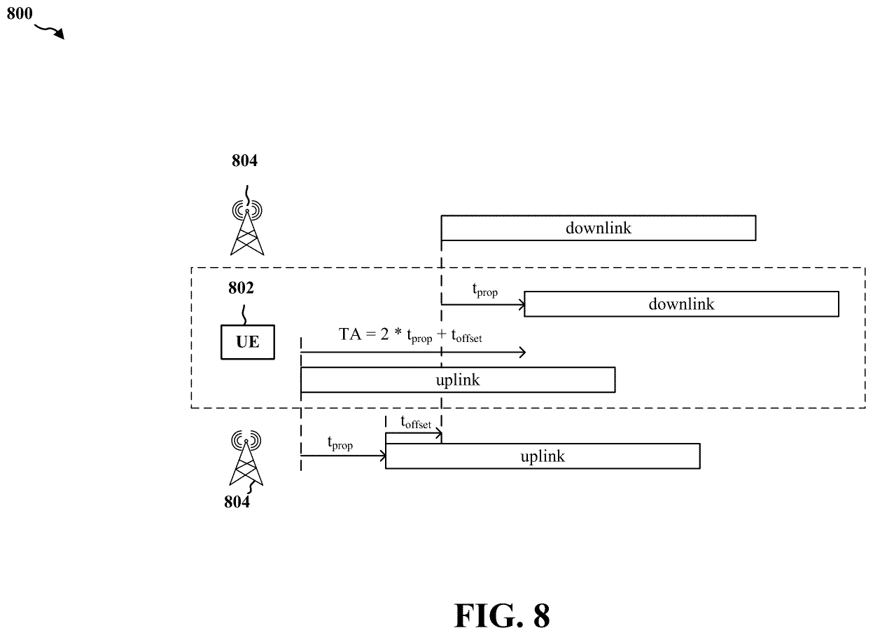

Aspects presented herein provide for improved inter-UE CLI mitigation, e.g., including for TDD scenarios. FIG. 7A illustrates an example of a first cell and a second cell for a sub-band non-overlapping full-duplex scenario, and FIG. 7B illustrates an example of the first cell and the second cell in a partial or full overlapping full-duplex scenario. In the first cell, a base station 702a transmits downlink communication to UE2 704b and receives uplink communication from UE1 704a in an SBFD manner, e.g., with the uplink and downlink communication overlapping in time, e.g., such as in the example in 520 in FIG. 5 or as in FIG. 6. The uplink transmission from the UE1 704a may cause inter-SB intra-cell CLI 712 to the UE2 704b. In the second cell, the base station 702b transmits downlink communication to the UE3 704c and receives uplink communication from UE4 704d in an SBFD manner. The uplink transmission from UE4 704d may cause inter-SB intra-cell inter-UE CLI 710 to the UE3 704c. e.g., as shown in connection with the time and frequency resources at 725. As well, the uplink transmission from the UE1 704a may cause inter-SB, inter-cell, inter-UE CLI 720 to the UE3 704c, as shown at 725. As well, the downlink communication from the base station 702b may cause inter-SB, inter-BS CLI 735 to the base station 702a, as shown at 727 based on SBFD resources. Additionally, the uplink communication scheduled by the base station 702a may cause interference to the downlink communication of the base station 702b. FIG. 7B illustrates an example in which the first cell and the second cell use partial or full overlapping full-duplex communication. The base station 702b may cause inter-BS CLI (in-band) 755 to the base station 702a. In contrast to FIG. 7A, the UE1 704a in FIG. 7B may cause intra-cell inter-UE CLI 756, e.g., rather than inter-SB intra-cell inter-UE CLI. Similarly, the UE1 704a may cause inter-cell inter-UE CLI 754 to the UE3 704c. The UE4 704d may cause intra-cell inter-UE CLI 752 to the UE3 704c. FIG. 8 is a diagram 800 illustrating example uplink/downlink timing at both base station and UE sides. The timing advance (TA) may be used to control the uplink transmission timing of individual UEs. The TA may help to ensure that uplink transmissions from all UE are synchronized when received by the base station. In particular, as shown, an uplink frame transmission from a UE 802 may start a time period before the start of the corresponding downlink frame at the UE. The time period may be referred to as the TA. In general, UEs closer to the base station may have shorter propagation delays (tₚᵣₒₚ), and hence smaller TAs. Conversely, UEs further away from the base station may have longer propagation delays, and hence greater TAs. The TA may account for the round trip propagation delay, i.e., 2*tₚᵣₒₚ. In addition, the TA may also include a timing offset t_{offset}. The purpose of the timing offset t_{offset} may be for a TDD base station (e.g., the TDD base station 804) to activate the transmitter of the base station after an uplink frame.

As shown in FIG. 8, as seen from the side of the UE 802, the reference point for the UE initial transmit timing control may be the downlink timing of the reference cell minus the TA. The downlink timing may be defined as the time when the first detected path (in time) of the corresponding downlink frame is received from the reference cell. Further, as seen from the side of the base station 804, the time difference between an uplink radio frame and the corresponding downlink radio frame may be the timing offset t_{offset}, which may be the same for all UEs attached to the base station 804. The propagation delay tₚᵣₒₚ may be already compensated at the UE side by the TA.

Due to the downlink timing and the uplink timing not being aligned, for a measuring UE to measure the UE-to-UE CLI, especially to measure the CLI-RSRP, timing adjustment may be needed. To achieve more accurate UE-to-UE CLI measurement, especially to support L1 and/or L2 (L1/L2) UE-to-UE CLI measurement (e.g., periodic measurements, aperiodic measurements, or semi-persistent measurements), in some aspects, a measuring (DL) UE may adjust the (current) timing of the measuring UE to a CLI measurement timing for the more accurate CLI measurement. To adjust the timing, the measuring UE may need to know the uplink transmission timing of the transmitting UE. As explained above, the uplink transmission timing of the transmitting UE may depend on the TA of the transmitting UE and the downlink timing of the transmitting UE.

In some configurations, for the CLI measurement, the victim UE associated with the UE-to-UE CLI may be the measuring UE and the aggressor UE associated with the UE-to-UE CLI may be the transmitting UE. In some other configurations, based on the inter-UE CLI channel reciprocity, for the CLI measurement, the victim UE associated with the UE-to-UE CLI may be the transmitting UE and the aggressor UE associated with the UE-to-UE CLI may be the measuring UE. If the aggressor UE serves as the measuring UE in the CLI measurement, the aggressor UE may forward the CLI measurement report to the victim UE, such that the victim UE may perform CLI mitigation operations based on the CLI measurement report.

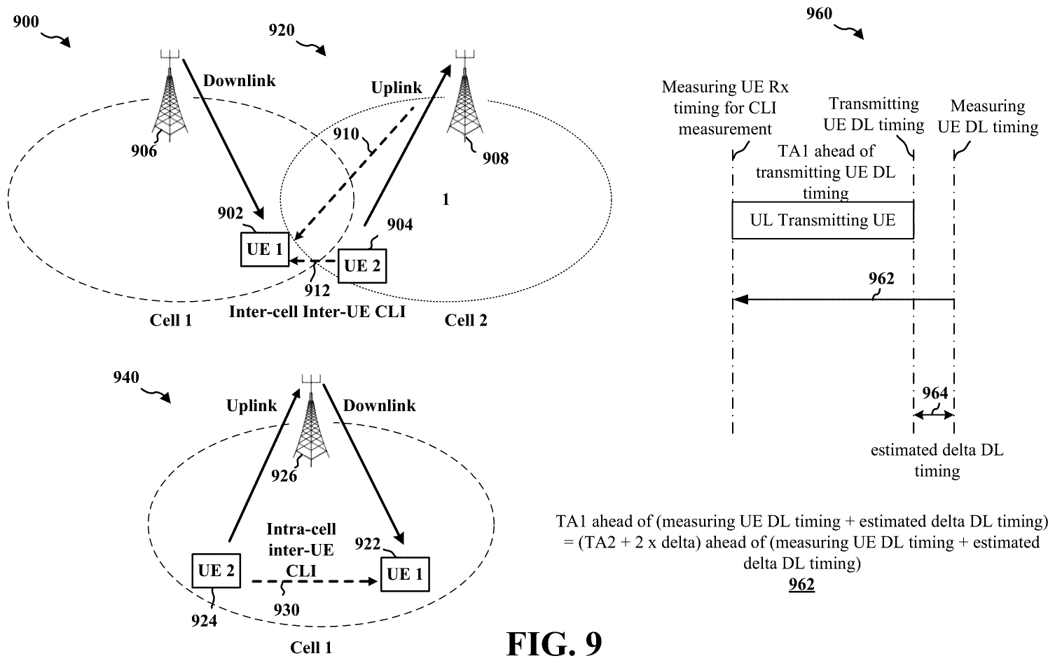

FIG. 9 is a diagram 900 illustrating example L1/L2 UE-to-UE CLI measurement according to one or more aspects. As explained above, for the L1/L2 UE-to-UE CLI measurement, the measuring DL UE may adjust the timing of the measuring UE to a CLI measurement timing for the more accurate CLI measurement. As shown, the diagram 920 may illustrate the measurement of the inter-cell UE-to-UE (i.e., inter-UE) CLI according to one or more aspects. In particular, for the measurement of the inter-cell inter-UE CLI 912, the first UE 902 may be the measuring UE and the second UE 904 may be the transmitting UE. Further, the serving cell of the first UE 902 may be a first cell associated with the network node 906 and the serving cell of the second UE 904 may be a second cell associated with the network node 908. In some aspects, to determine the amount of timing adjustment, the measuring UE 902 may measure a downlink RS (DL-RS) (e.g., an SSB) from the serving cell of the measuring UE (i.e., from the network node 906). Further, at 910, the measuring UE 902 may another DL-RS that may correspond to the transmitting UE from the serving cell of the transmitting UE (a non-serving cell for the measuring UE) (i.e., from the network node network node 908). The timing difference (time delta/delta time, or simply delta) between the receptions of the DL-RS from the serving cell of the measuring UE and of the DL-RS from the serving cell of the transmitting UE may correspond to the time delta (“delta”) 964 between the downlink timing of the transmitting UE and the downlink timing of the measuring UE, as shown in the diagram 960. Further, as shown in the diagram 960, the reception timing for the L1/L2 inter-UE CLI measurement at the measuring UE 902 may be the sum of the TA of the transmitting UE 904 (“TA1”) and the time delta ahead of the downlink timing of the measuring UE 902 (i.e., TA1 ahead of (downlink timing of the measuring UE+downlink timing delta), as shown at 962). Because the TA of the transmitting UE 904 (“TA1”) may be the sum of the TA of the measuring UE 902 (“TA2”) and 2 times the time delta (i.e., TA1=TA2+2*delta), the measuring UE 902 may adjust the reception timing of the measuring UE 902 for the L1/L2 inter-UE CLI measurement based on the TA of the measuring UE 902 (“TA2”) and the time delta. It should be appreciated that the time delta may be positive or negative.

In some configurations, the measuring UE 902 may need to know the identity of the serving cell of the transmitting UE 904 in order to measure the DL-RS from the serving cell of the transmitting UE 904 and adjust the reception timing for the L1/L2 inter-UE CLI measurement accordingly. Accordingly, in some configurations, the network node 906 may indicate the identity of the serving cell of the transmitting UE 904 (e.g., based on a cell identifier (ID) such as a PCI) to the measuring UE 902 (the serving cell of the transmitting UE 904 may be a neighbor/non-serving cell for the measuring UE 902). For example, the identity of the serving cell of the transmitting UE 904 may be indicated by the network node 906 in the CLI RS configuration. In different examples, the network node 906 may transmit the CLI RS configuration in an RRC message or a DCI message that triggers the L1/L2 inter-UE CLI measurement.

In some configurations, to identify the DL-RS (e.g., SSB) transmitted by the serving cell of the transmitting UE 904 for the transmitting UE 904, the measuring UE 902 may measure the multiple DL-RSs (e.g., SSBs) transmitted by the serving cell of the transmitting UE 904 (e.g., sweeping SSBs), and may assume that the DL-RS (e.g., SSB) associated with the greatest received signal strength (e.g., associated with the greatest RSRP) among the multiple DL-RSs (e.g., SSBs) to be the DL-RS (e.g., SSB) that may correspond to the transmitting UE 904. Based on the assumption, the measuring UE 902 may determine the time delta and adjust the reception timing for the L1/L2 inter-UE CLI measurement. This assumption may be valid because there is inter-UE CLI between the transmitting UE 904 and the measuring UE 902 and by inference the transmitting UE 904 and the measuring UE 902 may be close to each other.

Further, the diagram 940 may illustrate the measurement of the intra-cell UE-to-UE (i.e., inter-UE) CLI according to one or more aspects. For example, the measuring UE 922 and the transmitting UE 924 may perform SBFD operations. Further, the serving cell for the measuring UE 922 and the transmitting UE 924 may be the same cell that corresponds to the network node 926. Similar to the measuring UE 902 in the diagram 920, the measuring UE 922 may measure two DL-RSs (e.g., SSBs). One of the two measured DL-RSs may be associated with the measuring UE 922 itself and the other of the two measured DL-RSs may be associated with the transmitting UE 924. Accordingly, the measuring UE 922 may determine the time delta 964 between the downlink timing of the measuring UE 922 and the downlink timing of the transmitting UE 924 based on the timing difference between the receptions of the two DL-RSs. Then, similar to the measuring UE 902 in the diagram 920, to perform L1/L2 measurement of the inter-UE CLI 930 between the measuring UE 922 and the transmitting UE 924, the measuring UE 922 may adjust the reception timing of the measuring UE 922 based on the downlink timing of the measuring UE 922, the downlink timing delta, and the TA of the measuring UE 922.

In the scenario shown in the diagram 940, the network node 926 may indicate, to the measuring UE 922, the DL-RS (e.g., an SSB) associated with the transmitting UE 924, such that the measuring UE 922 may determine the downlink timing delta based on the measuring of the two DL-RSs. In particular, for example, the network node 926 may indicate, to the measuring UE 922, the index of the SSB associated with the greatest received signal strength (e.g., the greatest RSRP) at the transmitting UE 924. The SSB associated with the greatest received signal strength at the transmitting UE 924 may be the DL-RS associated with the transmitting UE 924. In some configurations, the network node 926 may indicate, to the measuring UE 922, the DL-RS (e.g., an SSB) associated with the transmitting UE 924 (i.e., assistance information) in a triggering DCI message or some other downlink signaling.

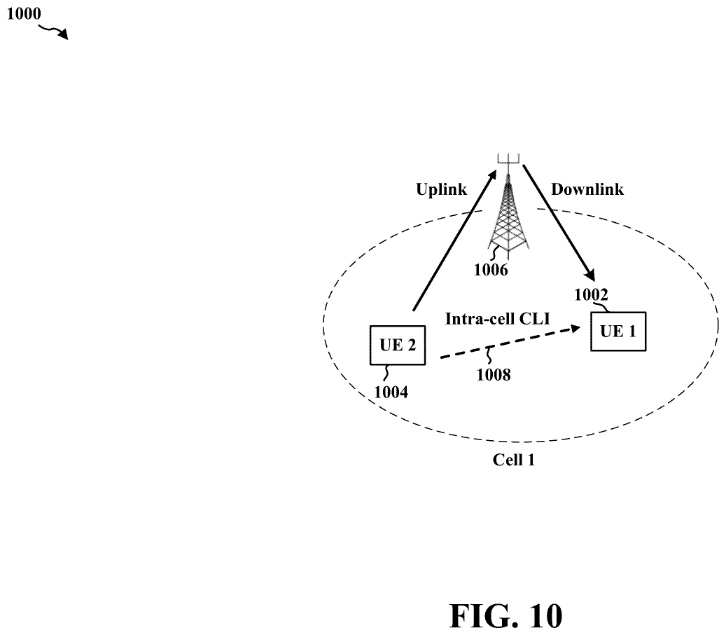

FIG. 10 is a diagram 1000 illustrating example L1/L2 measurement of intra-cell inter-UE CLI according to one or more aspects. As shown, the measuring UE 1002 and the transmitting UE 1004 may be served by a same serving cell corresponding to the network node 1006. To perform L1/L2 measurement of the inter-UE CLI 1008 between the measuring UE 1002 and the transmitting UE 1004, the measuring UE 1002 may adjust the reception timing of the measuring UE 1002. In some aspects, for more accurate timing adjustment, the measuring UE 1002 may measure the time difference (i.e., delta) between the downlink reception timing at the measuring UE 1002 (e.g., based on a reception from the network node 1006) and the reception/sensing timing associated with an (uplink) transmission from the transmitting UE 1004. In different examples, the (uplink) transmission from the transmitting UE 1004 may be one of a periodic or semi-persistent transmission that causes the inter-UE CLI 1008 (e.g., the transmission of a layer 3 (L3) CLI RS), an uplink transmission triggered by the network (e.g., the network node 1006), or an ongoing uplink transmission. Accordingly, in some configurations, the network node 1006 may indicate, to the measuring UE 1002, the (uplink) transmission from the transmitting UE 1004, such that the measuring UE 1002 may measure the time difference based on the (uplink) transmission from the transmitting UE 1004. Thereafter, for the L1/L2 measurement of the inter-UE CLI 1008, the measuring UE 1002 may adjust the reception timing of the measuring UE 1002 based on the downlink timing of the measuring UE 1002 and the measured delta. In particular, the adjusted reception timing for the L1/L2 measurement of the inter-UE CLI 1008 may be the delta ahead of the downlink timing of the measuring UE 1002 (i.e., the measuring UE 1002 may advance the reception timing from the downlink timing by the delta).

In some configurations, subsequent to the completion of the L1/L2 measurement of the inter-UE CLI 1008, the measuring UE 1002 may reset the timing per CLI RS or per UE (e.g., per pairing of two UEs) with an indication (i.e., a new signal) to the regular downlink reception timing of the measuring UE 1002 if needed.

In configurations where the measuring UE in the inter-UE CLI measurement is the aggressor UE and the transmitting UE is the victim UE in the inter-UE CLI, the measuring UE may forward the CLI measurement report to the transmitting UE so that the transmitting UE (victim UE) may perform CLI mitigation operations. In case the measuring UE and the transmitting UE are served by different cells, the measuring UE may first transmit the CLI measurement report to the serving cell of the measuring UE. Then, the serving cell of the measuring UE may forward the CLI measurement report to the serving cell of the transmitting UE (e.g., via backhaul signaling or over-the-air signaling between network nodes) for the CLI measurement report to be delivered to the transmitting UE (victim UE).

In some configurations, together with the CLI measurement report, the measuring UE may also forward an indication of the measured time delta to the transmitting UE. For example, the serving cell of the transmitting UE may signal the measured time delta to the transmitting UE using the TA framework (e.g., using one of an additional field in the MAC-control element (CE) (MAC-CE), an aperiodic CLI triggering DCI message, or some other downlink signaling).

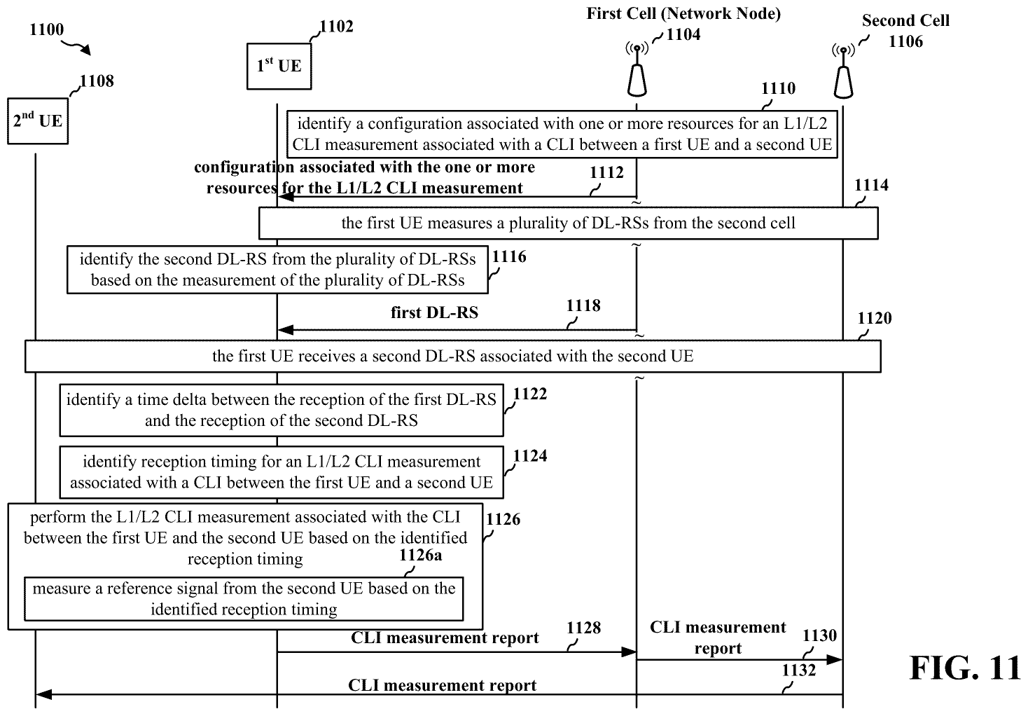

FIG. 11 is a diagram of a communication flow 1100 of a method of wireless communication. FIG. 11 may show the L1/L2 measurement of the inter-cell inter-UE CLI according to one or more aspects. As shown, the first UE 1102 may correspond to the measuring UE 902 in FIG. 9. The first cell (network node) 1104 may correspond to the network node 906 in FIG. 9. The second UE 1108 may correspond to the transmitting UE 904 in FIG. 9. Further, the second cell 1106 may correspond to the network node 908 in FIG. 9. Accordingly, a serving cell of the first UE 1102 may be the first cell 1104. Further, a serving cell of the second UE 1108 may be a second cell 1106. At 1110, the network node 1104 may identify a configuration associated with one or more resources for an L1/L2 CLI measurement associated with a CLI between a first UE 1102 and a second UE 1108.

In one or more configurations, the L1/L2 CLI measurement may be one of a periodic L1/L2 CLI measurement, an aperiodic L1/L2 CLI measurement, or a semi-persistent L1/L2 CLI measurement.

At 1112, the network node 1104 may transmit, for the first UE 1102, the configuration associated with the one or more resources for the L1/L2 CLI measurement via an RRC message or a DCI message. The configuration at 1112 may include an indication of the second cell 1106. The indication of the second cell 1106 may include a cell indication of the second cell 1106 or a PCI of the second cell 1106.

In one configuration, at 1114, the first UE 1102 may measure a plurality of DL-RSs from the second cell 1106.

In one configuration, the DCI message may trigger an aperiodic L1/L2 CLI measurement.

At 1116, the first UE 1102 may identify the second DL-RS from the plurality of DL-RSs based on the measurement, at 1114, of the plurality of DL-RSs. The second DL-RS may be associated with a greatest received strength in the plurality of DL-RSs.

In one configuration, at 1118, the first UE 1102 may receive a first DL-RS associated with the first UE 1102.

At 1120, the first UE 1102 may receive the second DL-RS associated with the second UE 1108.

In one configuration, each of the first DL-RS at 1118 or the second DL-RS at 1120 may include an SSB.

At 1122, the first UE 1102 may identify a time delta between the reception, at 1118, of the first DL-RS and the reception, at 1120, of the second DL-RS.

At 1124, the first UE 1102 may identify reception timing for an L1/L2 CLI measurement associated with a CLI between the first UE 1102 and a second UE 1108. In particular, the reception timing for the L1/L2 CLI measurement may be identified based on one or more of a TA of the first UE 1102, the time delta, or downlink timing of the first UE 1102.

At 1126, the first UE 1102 may perform the L1/L2 CLI measurement associated with the CLI between the first UE 1102 and the second UE 1108 based on the identified reception timing.

In one configuration, at 1126a, to perform the L1/L2 CLI measurement at 1126, the first UE 1102 may measure a reference signal from the second UE 1108 based on the identified reception timing.

In one configuration, the first UE 1102 may be a victim UE associated with the CLI between the first UE 1102 and the second UE 1108. The second UE 1108 may be an aggressor UE associated with the CLI between the first UE 1102 and the second UE 1108.

In one configuration, the first UE 1102 may be an aggressor UE associated with the CLI between the first UE 1102 and the second UE 1108. The second UE 1108 may be a victim UE associated with the CLI between the first UE 1102 and the second UE 1108. At 1128, the first UE 1102 may transmit, for the first cell 1104, a CLI measurement report based on the L1/L2 CLI measurement at 1126.

In one configuration, the CLI measurement report at 1128 may include an indication of the time delta identified at 1122.

In one configuration, the CLI measurement report may be forwarded to the second UE 1108 via the second cell 1106. For example, at 1130, the first cell 1104 may forward, to the second cell 1106, the CLI measurement report. Then, at 1132, the second cell 1106 may transmit, to the second UE 1108, the CLI measurement report. In one configuration, the second cell 1106 may signal the time delta in the TA framework by adding a field for the time delta for the CLI measurement purpose in one of a MAC-CE, a DCI message (e.g., a DCI that may trigger the aperiodic CLI measurement), or another downlink signal.

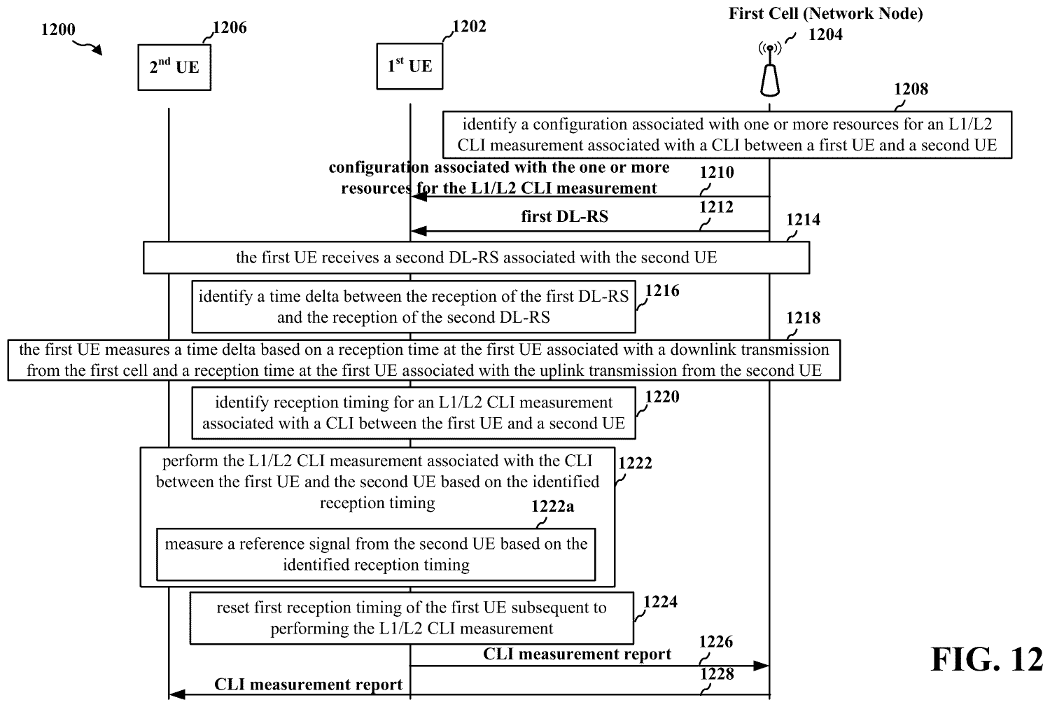

FIG. 12 is a diagram of a communication flow 1200 of a method of wireless communication. FIG. 12 may show the L1/L2 measurement of the intra-cell inter-UE CLI according to one or more aspects. As shown, the first UE 1202 may correspond to the measuring UE 922 in FIG. 9 or the measuring UE 1002 in FIG. 10. The first cell (network node) 1204 may correspond to network node 926 in FIG. 9 or the network node 1006 in FIG. 10. Further, the second UE 1206 may correspond to the transmitting UE 924 in FIG. 9 or the transmitting UE 1004 in FIG. 10. Accordingly, a serving cell of the first UE 1202 may be the first cell 1204. A serving cell of the second UE 1206 may be the first cell 1204. At 1208, the network node 1204 may identify a configuration associated with one or more resources for an L1/L2 CLI measurement associated with a CLI between a first UE 1202 and a second UE 1206.

In one or more configurations, the L1/L2 CLI measurement may be one of a periodic L1/L2 CLI measurement, an aperiodic L1/L2 CLI measurement, or a semi-persistent L1/L2 CLI measurement.

At 1210, the network node 1204 may transmit, for the first UE 1202, the configuration associated with the one or more resources for the L1/L2 CLI measurement via an RRC message or a DCI message.

In one configuration, the DCI message may trigger an aperiodic L1/L2 CLI measurement.

In some configurations, the reception timing for the L1/L2 CLI measurement may be determined, at 1220, based on 1212, 1214, and 1216. In these configurations, the configuration at 1210 may include an indication of the second DL-RS. At 1212, the first UE 1202 may receive a first DL-RS associated with the first UE 1202.

At 1214, the first UE 1202 may receive the second DL-RS associated with the second UE 1206.

In one configuration, each of the first DL-RS at 1212 or the second DL-RS at 1214 may include an SSB.

At 1216, the first UE 1202 may identify a time delta between the reception, at 1212, of the first DL-RS and the reception, at 1214, of the second DL-RS.

At 1220, the first UE 1202 may identify reception timing for an L1/L2 CLI measurement associated with a CLI between the first UE 1202 and a second UE 1206. In particular, the reception timing for the L1/L2 CLI measurement may be identified based on one or more of a TA of the first UE 1202, the time delta identified at 1216, or downlink timing of the first UE 1202.

In some configurations, the reception timing for the L1/L2 CLI measurement may be determined, at 1220, based on 1218. In these configurations, the configuration at 1210 may include an indication of an uplink transmission from the second UE 1206. At 1218, the first UE 1202 may measure a time delta based on a reception time at the first UE 1202 associated with a downlink transmission from the first cell 1204 and a reception time at the first UE 1202 associated with the uplink transmission from the second UE 1206.

At 1220, the first UE 1202 may identify reception timing for an L1/L2 CLI measurement associated with a CLI between the first UE 1202 and a second UE 1206. In particular, the reception timing for the L1/L2 CLI measurement may be identified based on downlink timing of the first UE 1202 and the time delta measured at 1218.

At 1222, the first UE 1202 may perform the L1/L2 CLI measurement associated with the CLI between the first UE 1202 and the second UE 1206 based on the identified reception timing.

In one configuration, at 1222a, to perform the L1/L2 CLI measurement at 1222, the first UE 1202 may measure a reference signal from the second UE 1206 based on the identified reception timing.

In one configuration, at 1224, the first UE 1202 may reset first reception timing of the first UE 1202 to downlink reception timing of the first UE 1202 subsequent to performing the L1/L2 CLI measurement at 1222.

In one configuration, the first UE 1202 may be a victim UE associated with the CLI between the first UE 1202 and the second UE 1206. The second UE 1206 may be an aggressor UE associated with the CLI between the first UE 1202 and the second UE 1206.

In one configuration, the first UE 1202 may be an aggressor UE associated with the CLI between the first UE 1202 and the second UE 1206. The second UE 1206 may be a victim UE associated with the CLI between the first UE 1202 and the second UE 1206. At 1226, the first UE 1202 may transmit, for the first cell 1204, a CLI measurement report based on the L1/L2 CLI measurement at 1222.

In one configuration, the CLI measurement report at 1226 may include an indication of the time delta identified/measured at 1216/1218.

In one configuration, at 1228, the first cell 1204 may forward, to the second UE 1206, the CLI measurement report.

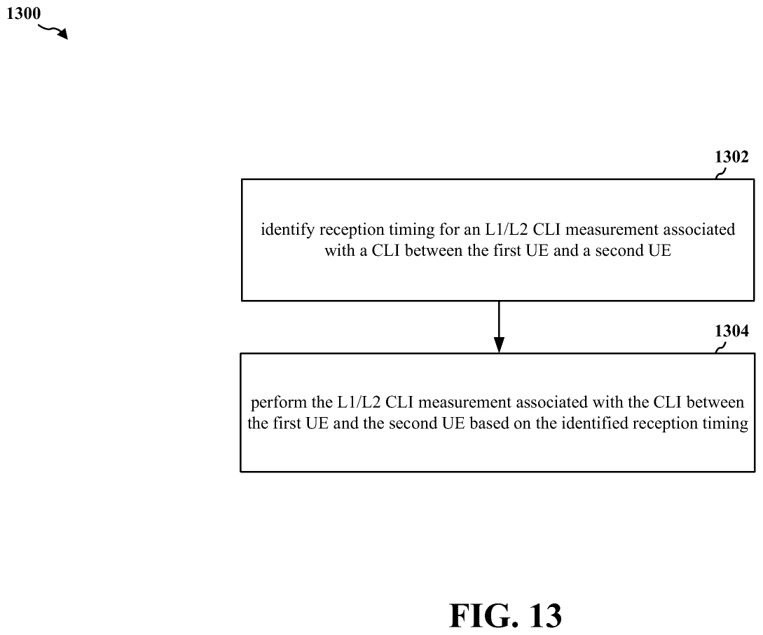

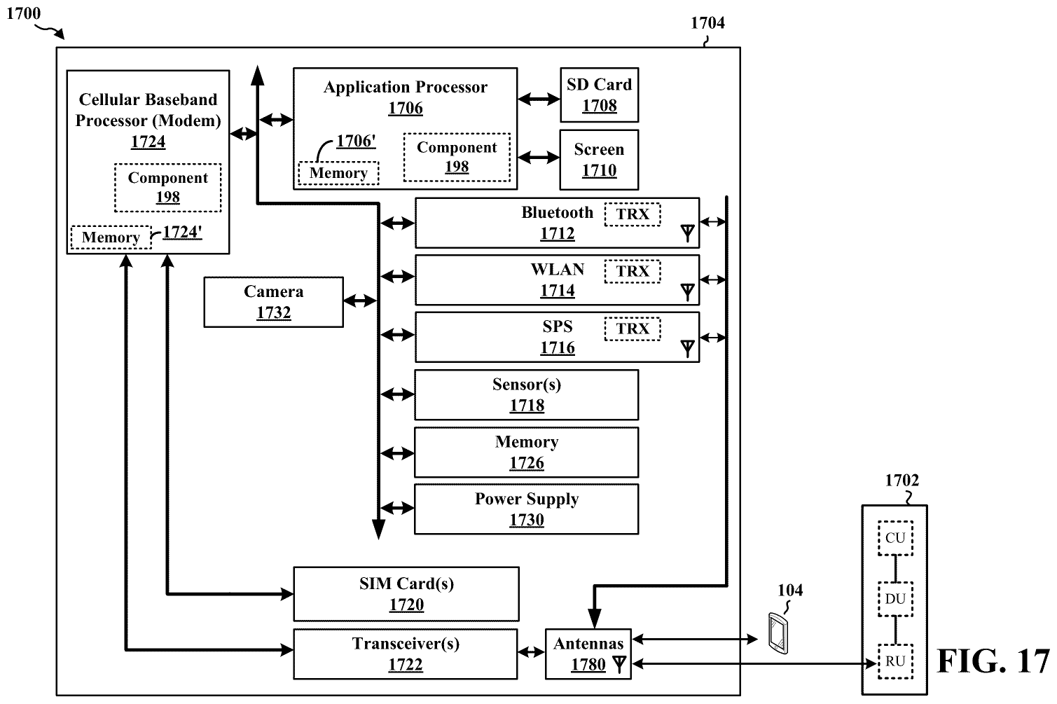

FIG. 13 is a flowchart 1300 of a method of wireless communication. The method may be performed by a first UE (e.g., the UE 104/350; the first UE 902/922/1002/1102/1202; the apparatus 1704). At 1302, the first UE may identify reception timing for an L1/L2 CLI measurement associated with a CLI between the first UE and a second UE. For example, 1302 may be performed by the component 198 in FIG. 17. Referring to FIGS. 11 and 12, at 1124, 1220, the first UE 1102/1202 may identify reception timing for an L1/L2 CLI measurement associated with a CLI between the first UE 1102/1202 and a second UE 1108/1206.

At 1304, the first UE may perform the L1/L2 CLI measurement associated with the CLI between the first UE and the second UE based on the identified reception timing. For example, 1304 may be performed by the component 198 in FIG. 17. Referring to FIGS. 11 and 12, at 1126, 1222, the first UE 1102/1202 may perform the L1/L2 CLI measurement associated with the CLI between the first UE 1102/1202 and the second UE 1108/1206 based on the identified reception timing.

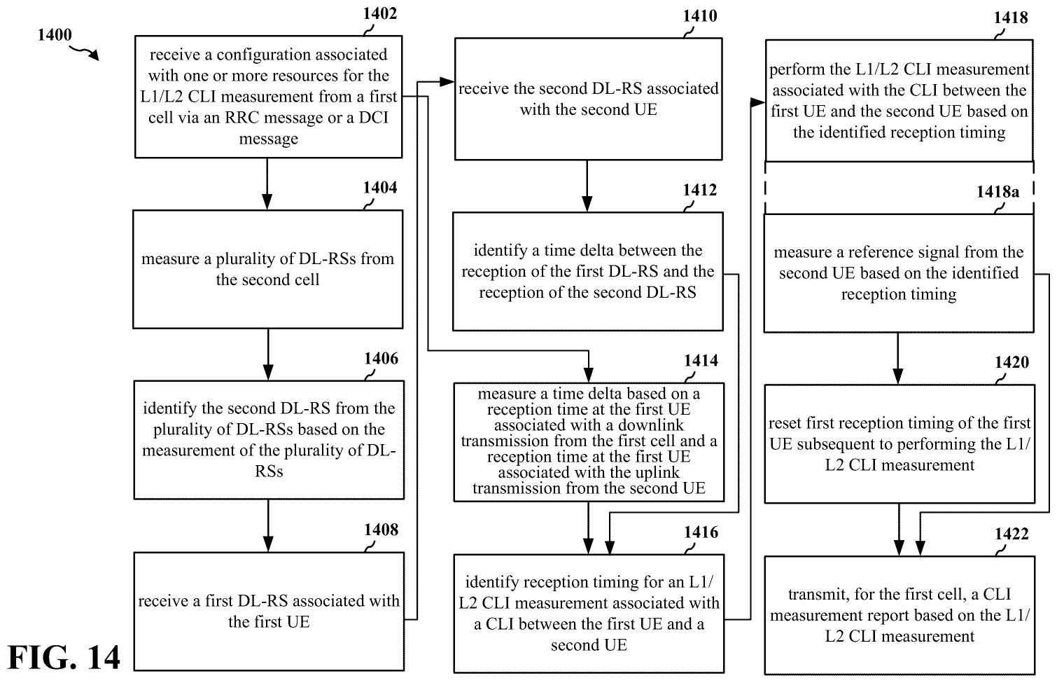

FIG. 14 is a flowchart 1400 of a method of wireless communication. The method may be performed by a first UE (e.g., the UE 104/350; the first UE 902/922/1002/1102/1202; the apparatus 1704). At 1416, the first UE may identify reception timing for an L1/L2 CLI measurement associated with a CLI between the first UE and a second UE. For example, 1416 may be performed by the component 198 in FIG. 17. Referring to FIGS. 11 and 12, at 1124, 1220, the first UE 1102/1202 may identify reception timing for an L1/L2 CLI measurement associated with a CLI between the first UE 1102/1202 and a second UE 1108/1206.

At 1418, the first UE may perform the L1/L2 CLI measurement associated with the CLI between the first UE and the second UE based on the identified reception timing. For example, 1418 may be performed by the component 198 in FIG. 17. Referring to FIGS. 11 and 12, at 1126, 1222, the first UE 1102/1202 may perform the L1/L2 CLI measurement associated with the CLI between the first UE 1102/1202 and the second UE 1108/1206 based on the identified reception timing.

In one configuration, at 1402, the first UE may receive a configuration associated with one or more resources for the L1/L2 CLI measurement from a first cell via an RRC message or a DCI message. For example, 1402 may be performed by the component 198 in FIG. 17. Referring to FIGS. 11 and 12, at 1112, 1210, the first UE 1102/1202 may receive a configuration associated with one or more resources for the L1/L2 CLI measurement from a first cell 1104/1204 via an RRC message or a DCI message.

In one configuration, at 1408, the first UE may receive a first DL-RS associated with the first UE. For example, 1408 may be performed by the component 198 in FIG. 17. Referring to FIGS. 11 and 12, at 1118, 1212, the first UE 1102/1202 may receive a first DL-RS associated with the first UE 1102/1202.

At 1410, the first UE may receive a second DL-RS associated with the second UE. For example, 1410 may be performed by the component 198 in FIG. 17. Referring to FIGS. 11 and 12, at 1120, 1214, the first UE 1102/1202 may receive a second DL-RS associated with the second UE 1108/1206.

At 1412, the first UE may identify a time delta between the reception of the first DL-RS and the reception of the second DL-RS. The reception timing for the L1/L2 CLI measurement may be identified based on one or more of a TA of the first UE, the time delta, or downlink timing of the first UE. For example, 1412 may be performed by the component 198 in FIG. 17. Referring to FIGS. 11 and 12, at 1122, 1216, the first UE 1102/1202 may identify a time delta between the reception, at 1118, 1212, of the first DL-RS and the reception, at 1120, 1214, of the second DL-RS.

In one configuration, each of the first DL-RS at 1118, 1212 or the second DL-RS at 1120, 1214 may include an SSB.

In one configuration, referring to FIG. 11, a serving cell of the first UE 1102 may be the first cell 1104. A serving cell of the second UE 1108 may be a second cell 1106. The configuration at 1112 may include an indication of the second cell 1106. The indication of the second cell 1106 may include a cell indication of the second cell 1106 or a PCI of the second cell 1106. At 1404, the first UE may measure a plurality of DL-RSs from the second cell. For example, 1404 may be performed by the component 198 in FIG. 17. Referring to FIG. 11, at 1114, the first UE 1102 may measure a plurality of DL-RSs from the second cell 1106.

At 1406, the first UE may identify the second DL-RS from the plurality of DL-RSs based on the measurement of the plurality of DL-RSs. The second DL-RS may be associated with a greatest received strength in the plurality of DL-RSs. For example, 1406 may be performed by the component 198 in FIG. 17. Referring to FIG. 11, at 1116, the first UE 1102 may identify the second DL-RS from the plurality of DL-RSs based on the measurement, at 1114, of the plurality of DL-RSs.

In one configuration, referring to FIG. 12, a serving cell of the first UE 1202 may be the first cell 1204. A serving cell of the second UE 1206 may be the first cell 1204. The second DL-RS may be an SSB associated with a greatest received strength at the second UE 1206. The configuration at 1210 may include an indication of the second DL-RS at 1214.

In one configuration, referring to FIG. 12, a serving cell of the first UE 1202 may be the first cell 1204. A serving cell of the second UE 1206 may be the first cell 1204. The configuration at 1210 may include an indication of an uplink transmission from the second UE 1206. At 1414, the first UE may measure a time delta based on a reception time at the first UE associated with a downlink transmission from the first cell and a reception time at the first UE associated with the uplink transmission from the second UE. The reception timing for the L1/L2 CLI measurement may be identified based on downlink timing of the first UE and the time delta. For example, 1414 may be performed by the component 198 in FIG. 17. Referring to FIG. 12, at 1218, the first UE 1202 may measure a time delta based on a reception time at the first UE 1202 associated with a downlink transmission from the first cell 1204 and a reception time at the first UE 1202 associated with the uplink transmission from the second UE 1206.

In one configuration, referring to FIG. 12, the uplink transmission at 1218 from the second UE 1206 may be based on one of a periodic scheduling, a semi-persistent scheduling, or a triggering by the first cell 1204.

In one configuration, at 1420, the first UE may reset first reception timing of the first UE to downlink reception timing of the first UE subsequent to performing the L1/L2 CLI measurement. For example, 1420 may be performed by the component 198 in FIG. 17. Referring to FIG. 12, at 1224, the first UE 1202 may reset first reception timing of the first UE 1202 to downlink reception timing of the first UE 1202 subsequent to performing the L1/L2 CLI measurement at 1222.

In one configuration, the DCI message may trigger an aperiodic L1/L2 CLI measurement.

In one configuration, referring to FIGS. 11 and 12, the first UE 1102/1202 may be a victim UE associated with the CLI between the first UE 1102/1202 and the second UE 1108/1206. The second UE 1108/1206 may be an aggressor UE associated with the CLI between the first UE 1102/1202 and the second UE 1108/1206.

In one configuration, referring to FIGS. 11 and 12, the first UE 1102/1202 may be an aggressor UE associated with the CLI between the first UE 1102/1202 and the second UE 1108/1206. The second UE 1108/1206 may be a victim UE associated with the CLI between the first UE 1102/1202 and the second UE 1108/1206. At 1422, the first UE may transmit, for a first cell, a CLI measurement report based on the L1/L2 CLI measurement. The CLI measurement report may be forwarded to the second UE. For example, 1422 may be performed by the component 198 in FIG. 17. Referring to FIGS. 11 and 12, at 1128, 1226, the first UE 1102/1202 may transmit, for a first cell 1104/1204, a CLI measurement report based on the L1/L2 CLI measurement at 1126/1222.

In one configuration, referring to FIGS. 11 and 12, the CLI measurement report at 1128, 1226 may include an indication of a time delta.

In one configuration, to perform the L1/L2 CLI measurement at 1418, at 1418a, the first UE may measure a reference signal from the second UE based on the identified reception timing. The L1/L2 CLI measurement may be based on a CLI-RSRP of the reference signal from the second UE. For example, 1418a may be performed by the component 198 in FIG. 17. Referring to FIGS. 11 and 12, at 1126a, 1222a, the first UE 1102/1202 may measure a reference signal from the second UE 1108/1206 based on the identified reception timing.

In one or more configurations, referring to FIGS. 11 and 12, the L1/L2 CLI measurement at 1126, 1222 may be one of a periodic L1/L2 CLI measurement, an aperiodic L1/L2 CLI measurement, or a semi-persistent L1/L2 CLI measurement.

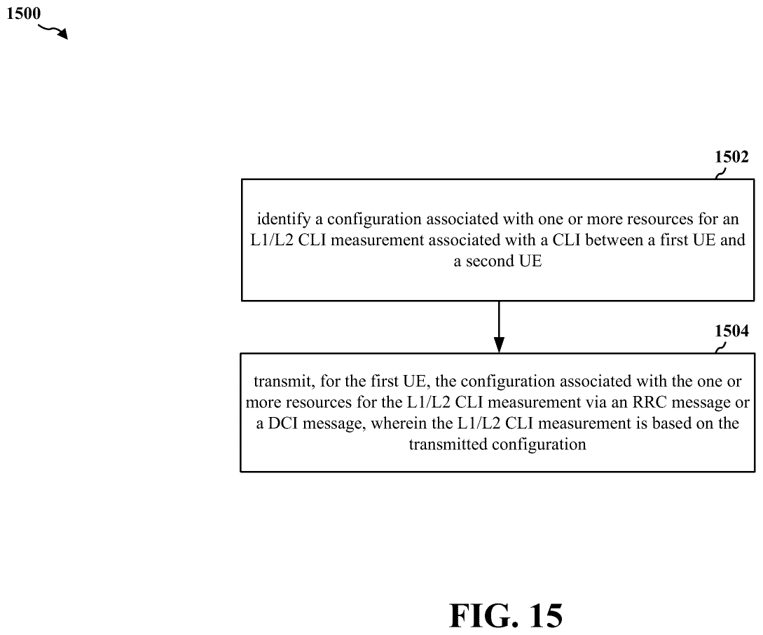

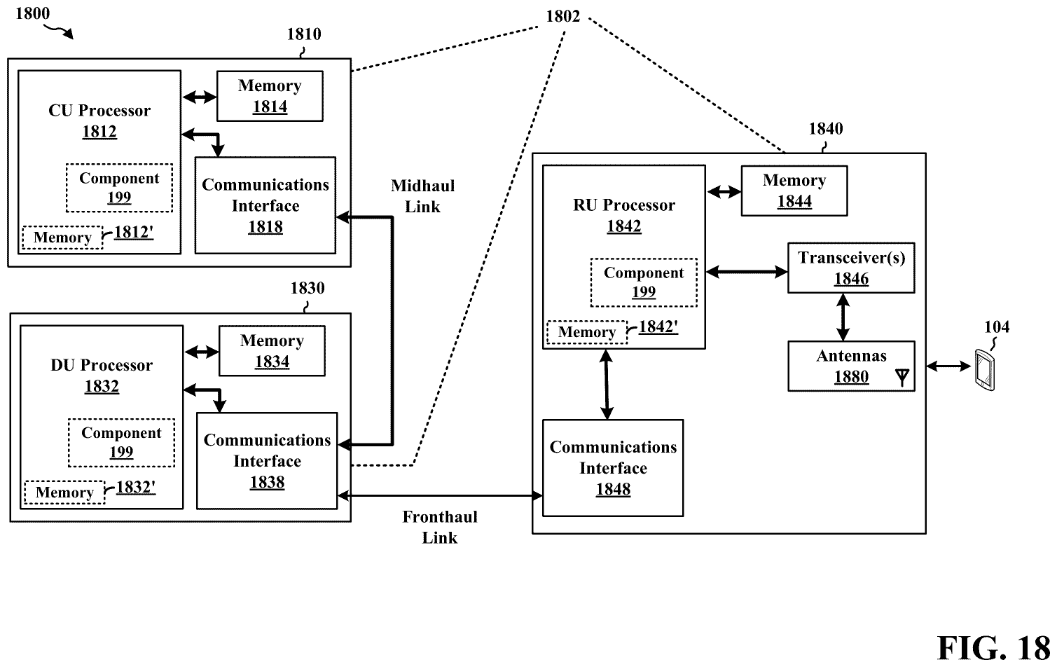

FIG. 15 is a flowchart 1500 of a method of wireless communication. The method may be performed by a network node (e.g., the base station 102/310; the first cell/network node 906/926/1006/1104/1204; the network entity 1702, 1802). At 1502, the network node may identify a configuration associated with one or more resources for an L1/L2 CLI measurement associated with a CLI between a first UE and a second UE. For example, 1502 may be performed by the component 199 in FIG. 18. Referring to FIGS. 11 and 12, at 1110, 1208, the network node 1104/1204 may identify a configuration associated with one or more resources for an L1/L2 CLI measurement associated with a CLI between a first UE 1102/1202 and a second UE 1108/1206.

At 1504, the network node may transmit, for the first UE, the configuration associated with the one or more resources for the L1/L2 CLI measurement via an RRC message or a DCI message. The L1/L2 CLI measurement may be based on the transmitted configuration. For example, 1504 may be performed by the component 199 in FIG. 18. Referring to FIGS. 11 and 12, at 1112, 1210, the network node 1104/1204 may transmit, for the first UE 1102/1202, the configuration associated with the one or more resources for the L1/L2 CLI measurement via an RRC message or a DCI message.

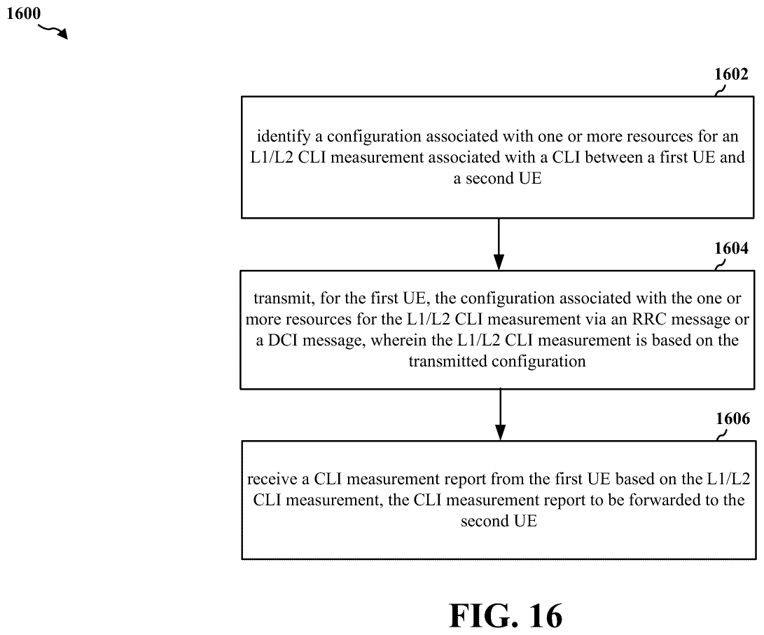

FIG. 16 is a flowchart 1600 of a method of wireless communication. The method may be performed by a network node (e.g., the base station 102/310; the first cell/network node 906/926/1006/1104/1204; the network entity 1702, 1802). At 1602, the network node may identify a configuration associated with one or more resources for an L1/L2 CLI measurement associated with a CLI between a first UE and a second UE. For example, 1602 may be performed by the component 199 in FIG. 18. Referring to FIGS. 11 and 12, at 1110, 1208, the network node 1104/1204 may identify a configuration associated with one or more resources for an L1/L2 CLI measurement associated with a CLI between a first UE 1102/1202 and a second UE 1108/1206.

At 1604, the network node may transmit, for the first UE, the configuration associated with the one or more resources for the L1/L2 CLI measurement via an RRC message or a DCI message. The L1/L2 CLI measurement may be based on the transmitted configuration. For example, 1604 may be performed by the component 199 in FIG. 18. Referring to FIGS. 11 and 12, at 1112, 1210, the network node 1104/1204 may transmit, for the first UE 1102/1202, the configuration associated with the one or more resources for the L1/L2 CLI measurement via an RRC message or a DCI message.

In one configuration, referring to FIG. 12, the network node 1204 may correspond to a serving cell of the first UE 1202 and of the second UE 1206.

In one configuration, referring to FIG. 12, the configuration at 1210 may include an indication of a DL-RS associated with the second UE 1206.

In one configuration, referring to FIG. 12, the configuration at 1210 may include an indication of an uplink transmission from the second UE 1206.

In one configuration, referring to FIG. 12, the uplink transmission at 1218 from the second UE 1206 may be based on one of a periodic scheduling, a semi-persistent scheduling, or a triggering by the network node 1204.

In one configuration, referring to FIG. 11, the network node 1104 may correspond to a serving cell of the first UE 1102. The configuration at 1112 may include an indication of a second network node (second cell) 1106. The indication of the second network node (second cell) 1106 may include a cell indication of the second network node (second cell) 1106 or a PCI of the second network node (second cell) 1106. The second network node (second cell) 1106 may correspond to a serving cell of the second UE 1108.

In one configuration, referring to FIGS. 11 and 12, the first UE 1102/1202 may be a victim UE associated with the CLI between the first UE 1102/1202 and the second UE 1108/1206. The second UE 1108/1206 may be an aggressor UE associated with the CLI between the first UE 1102/1202 and the second UE 1108/1206.

In one configuration, referring to FIGS. 11 and 12, the first UE 1102/1202 may be an aggressor UE associated with the CLI between the first UE 1102/1202 and the second UE 1108/1206. The second UE 1108/1206 may be a victim UE associated with the CLI between the first UE 1102/1202 and the second UE 1108/1206. At 1606, the network node may receive a CLI measurement report from the first UE based on the L1/L2 CLI measurement. The CLI measurement report may be forwarded to the second UE directly or via a second network node (second cell) 1106 that may correspond to a serving cell of the second UE 1108. For example, 1606 may be performed by the component 199 in FIG. 18. Referring to FIGS. 11 and 12, at 1128, 1226, the network node 1104/1204 may receive a CLI measurement report from the first UE 1102/1202 based on the L1/L2 CLI measurement at 1126/1222.

In one configuration, referring to FIGS. 11 and 12, the CLI measurement report at 1128, 1226 may include an indication of a time delta.

In one configuration, the DCI message may trigger an aperiodic L1/L2 CLI measurement.

In one configuration, referring to FIGS. 11 and 12, the L1/L2 CLI measurement at 1126, 1222 may be one of a periodic L1/L2 CLI measurement, an aperiodic L1/L2 CLI measurement, or a semi-persistent L1/L2 CLI measurement. The L1/L2 CLI measurement at 1126, 1222 may be based on a CLI-RSRP of a reference signal from the second UE 1108, 1206.

FIG. 17 is a diagram 1700 illustrating an example of a hardware implementation for an apparatus 1704. The apparatus 1704 may be a UE, a component of a UE, or may implement UE functionality. In some aspects, the apparatus 1704 may include a cellular baseband processor 1724 (also referred to as a modem) coupled to one or more transceivers 1722 (e.g., cellular RF transceiver). The cellular baseband processor 1724 may include on-chip memory 1724′. In some aspects, the apparatus 1704 may further include one or more subscriber identity modules (SIM) cards 1720 and an application processor 1706 coupled to a secure digital (SD) card 1708 and a screen 1710. The application processor 1706 may include on-chip memory 1706′. In some aspects, the apparatus 1704 may further include a Bluetooth module 1712, a WLAN module 1714, an SPS module 1716 (e.g., GNSS module), one or more sensor modules 1718 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1726, a power supply 1730, and/or a camera 1732. The Bluetooth module 1712, the WLAN module 1714, and the SPS module 1716 may include an on-chip transceiver (TRX) (or in some cases, just a receiver (RX)). The Bluetooth module 1712, the WLAN module 1714, and the SPS module 1716 may include their own dedicated antennas and/or utilize the antennas 1780 for communication. The cellular baseband processor 1724 communicates through the transceiver(s) 1722 via one or more antennas 1780 with the UE 104 and/or with an RU associated with a network entity 1702. The cellular baseband processor 1724 and the application processor 1706 may each include a computer-readable medium/memory 1724′, 1706′, respectively. The additional memory modules 1726 may also be considered a computer-readable medium/memory. Each computer-readable medium/memory 1724′, 1706′, 1726 may be non-transitory. The cellular baseband processor 1724 and the application processor 1706 are each responsible for general processing, including the execution of software stored on the computer-readable medium/memory. The software, when executed by the cellular baseband processor 1724/application processor 1706, causes the cellular baseband processor 1724/application processor 1706 to perform the various functions described supra. The computer-readable medium/memory may also be used for storing data that is manipulated by the cellular baseband processor 1724/application processor 1706 when executing software. The cellular baseband processor 1724/application processor 1706 may be a component of the UE 350 and may include the memory 360 and/or at least one of the TX processor 368, the RX processor 356, and the controller/processor 359. In one configuration, the apparatus 1704 may be a processor chip (modem and/or application) and include just the cellular baseband processor 1724 and/or the application processor 1706, and in another configuration, the apparatus 1704 may be the entire UE (e.g., see UE 350 of FIG. 3) and include the additional modules of the apparatus 1704.

As discussed supra, the component 198 may be configured to identify reception timing for an L1/L2 CLI measurement associated with a CLI between the first UE and a second UE. The component 198 may be configured to perform the L1/L2 CLI measurement associated with the CLI between the first UE and the second UE based on the identified reception timing. The component 198 may be within the cellular baseband processor 1724, the application processor 1706, or both the cellular baseband processor 1724 and the application processor 1706. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1704 may include a variety of components configured for various functions. In one configuration, the apparatus 1704, and in particular the cellular baseband processor 1724 and/or the application processor 1706, may include means for identifying reception timing for an L1/L2 CLI measurement associated with a CLI between the first UE and a second UE. The apparatus 1704, and in particular the cellular baseband processor 1724 and/or the application processor 1706, may include means for performing the L1/L2 CLI measurement associated with the CLI between the first UE and the second UE based on the identified reception timing.

In one configuration, the apparatus 1704, and in particular the cellular baseband processor 1724 and/or the application processor 1706, may include means for receiving a configuration associated with one or more resources for the L1/L2 CLI measurement from a first cell via an RRC message or a DCI message. In one configuration, the apparatus 1704, and in particular the cellular baseband processor 1724 and/or the application processor 1706, may include means for receiving a first DL-RS associated with the first UE. The apparatus 1704, and in particular the cellular baseband processor 1724 and/or the application processor 1706, may include means for receiving a second DL-RS associated with the second UE. The apparatus 1704, and in particular the cellular baseband processor 1724 and/or the application processor 1706, may include means for identifying a time delta between the reception of the first DL-RS and the reception of the second DL-RS. The reception timing for the L1/L2 CLI measurement may be identified based on one or more of a TA of the first UE, the time delta, or downlink timing of the first UE. In one configuration, each of the first DL-RS or the second DL-RS may include an SSB. In one configuration, a serving cell of the first UE may be the first cell. A serving cell of the second UE may be a second cell. The configuration may include an indication of the second cell. The indication of the second cell may include a cell indication of the second cell or a PCI of the second cell. The apparatus 1704, and in particular the cellular baseband processor 1724 and/or the application processor 1706, may include means for measuring a plurality of DL-RSs from the second cell. The apparatus 1704, and in particular the cellular baseband processor 1724 and/or the application processor 1706, may include means for identifying the second DL-RS from the plurality of DL-RSs based on the measurement of the plurality of DL-RSs. The second DL-RS may be associated with a greatest received strength in the plurality of DL-RSs. In one configuration, a serving cell of the first UE may be the first cell. A serving cell of the second UE may be the first cell. The second DL-RS may correspond to an SSB associated with a greatest received strength at the second UE. The configuration may include an indication of the second DL-RS. In one configuration, a serving cell of the first UE may be the first cell. A serving cell of the second UE may be the first cell. The configuration may include an indication of an uplink transmission from the second UE. The apparatus 1704, and in particular the cellular baseband processor 1724 and/or the application processor 1706, may include means for measuring a time delta based on the uplink transmission from the second UE. The reception timing for the L1/L2 CLI measurement may be identified based on downlink timing of the first UE and the time delta. In one configuration, the uplink transmission from the second UE may be based on one of a periodic scheduling, a semi-persistent scheduling, or a triggering by the first cell. In one configuration, the apparatus 1704, and in particular the cellular baseband processor 1724 and/or the application processor 1706, may include means for resetting first reception timing of the first UE to downlink reception timing of the first UE subsequent to performing the L1/L2 CLI measurement. In one configuration, the DCI message may trigger an aperiodic L1/L2 CLI measurement. In one configuration, the first UE may be a victim UE associated with the CLI between the first UE and the second UE. The second UE may be an aggressor UE associated with the CLI between the first UE and the second UE. In one configuration, the first UE may be an aggressor UE associated with the CLI between the first UE and the second UE. The second UE may be a victim UE associated with the CLI between the first UE and the second UE. The apparatus 1704, and in particular the cellular baseband processor 1724 and/or the application processor 1706, may include means for transmitting, for a first cell, a CLI measurement report based on the L1/L2 CLI measurement. The CLI measurement report may be forwarded to the second UE. In one configuration, the CLI measurement report may include an indication of a time delta. In one configuration, the means for performing the L1/L2 CLI measurement may be further configured to: measure a reference signal from the second UE based on the identified reception timing. The L1/L2 CLI measurement may be based on a CLI-RSRP of the reference signal from the second UE. In one configuration, the L1/L2 CLI measurement may be one of a periodic L1/L2 CLI measurement, an aperiodic L1/L2 CLI measurement, or a semi-persistent L1/L2 CLI measurement.

The means may be the component 198 of the apparatus 1704 configured to perform the functions recited by the means. As described supra, the apparatus 1704 may include the TX processor 368, the RX processor 356, and the controller/processor 359. As such, in one configuration, the means may be the TX processor 368, the RX processor 356, and/or the controller/processor 359 configured to perform the functions recited by the means.

FIG. 18 is a diagram 1800 illustrating an example of a hardware implementation for a network entity 1802. The network entity 1802 may be a BS, a component of a BS, or may implement BS functionality. The network entity 1802 may include at least one of a CU 1810, a DU 1830, or an RU 1840. For example, depending on the layer functionality handled by the component 199, the network entity 1802 may include the CU 1810; both the CU 1810 and the DU 1830; each of the CU 1810, the DU 1830, and the RU 1840; the DU 1830; both the DU 1830 and the RU 1840; or the RU 1840. The CU 1810 may include a CU processor 1812. The CU processor 1812 may include on-chip memory 1812′. In some aspects, the CU 1810 may further include additional memory modules 1814 and a communications interface 1818. The CU 1810 communicates with the DU 1830 through a midhaul link, such as an F1 interface. The DU 1830 may include a DU processor 1832. The DU processor 1832 may include on-chip memory 1832′. In some aspects, the DU 1830 may further include additional memory modules 1834 and a communications interface 1838. The DU 1830 communicates with the RU 1840 through a fronthaul link. The RU 1840 may include an RU processor 1842. The RU processor 1842 may include on-chip memory 1842′. In some aspects, the RU 1840 may further include additional memory modules 1844, one or more transceivers 1846, antennas 1880, and a communications interface 1848. The RU 1840 communicates with the UE 104. The on-chip memory 1812′, 1832′, 1842′ and the additional memory modules 1814, 1834, 1844 may each be considered a computer-readable medium/memory. Each computer-readable medium/memory may be non-transitory. Each of the processors 1812, 1832, 1842 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 may be configured to identify a configuration associated with one or more resources for an L1/L2 CLI measurement associated with a CLI between a first UE and a second UE. The component 199 may be configured to transmit, for the first UE, the configuration associated with the one or more resources for the L1/L2 CLI measurement via an RRC message or a DCI message. The L1/L2 CLI measurement may be based on the transmitted configuration. The component 199 may be within one or more processors of one or more of the CU 1810, DU 1830, and the RU 1840. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1802 may include a variety of components configured for various functions. In one configuration, the network entity 1802 may include means for identifying a configuration associated with one or more resources for an L1/L2 CLI measurement associated with a CLI between a first UE and a second UE. The network entity 1802 may include means for transmitting, for the first UE, the configuration associated with the one or more resources for the L1/L2 CLI measurement via an RRC message or a DCI message. The L1/L2 CLI measurement may be based on the transmitted configuration.

In one configuration, the network node may correspond to a serving cell of the first UE and of the second UE. In one configuration, the configuration may include an indication of a DL-RS associated with the second UE. In one configuration, the configuration may include an indication of an uplink transmission from the second UE. In one configuration, the uplink transmission from the second UE may be based on one of a periodic scheduling, a semi-persistent scheduling, or a triggering by the network node. In one configuration, the network node may correspond to a serving cell of the first UE. The configuration may include an indication of a second network node. The indication of the second network node may include a cell indication of the second network node or a PCI of the second network node. The second network node corresponds to a serving cell of the second UE. In one configuration, the first UE may be a victim UE associated with the CLI between the first UE and the second UE. The second UE may be an aggressor UE associated with the CLI between the first UE and the second UE. In one configuration, the first UE may be an aggressor UE associated with the CLI between the first UE and the second UE. The second UE may be a victim UE associated with the CLI between the first UE and the second UE. The network entity 1802 may include means for receiving a CLI measurement report from the first UE based on the L1/L2 CLI measurement. The CLI measurement report may be forwarded to the second UE directly or via a second network node that corresponds to a serving cell of the second UE. In one configuration, the CLI measurement report may include an indication of a time delta. In one configuration, the DCI message may trigger an aperiodic L1/L2 CLI measurement. In one configuration, the L1/L2 CLI measurement may be one of a periodic L1/L2 CLI measurement, an aperiodic L1/L2 CLI measurement, or a semi-persistent L1/L2 CLI measurement. The L1/L2 CLI measurement may be based on a CLI-RSRP of a reference signal from the second UE.

The means may be the component 199 of the network entity 1802 configured to perform the functions recited by the means. As described supra, the network entity 1802 may include the TX processor 316, the RX processor 370, and the controller/processor 375. As such, in one configuration, the means may be the TX processor 316, the RX processor 370, and/or the controller/processor 375 configured to perform the functions recited by the means.

Referring back to FIGS. 4-18, a network node (first cell) may identify a configuration associated with one or more resources for an L1/L2 CLI measurement associated with a CLI between a first UE and a second UE. The network node (first cell) may transmit, for the first UE, the configuration associated with the one or more resources for the L1/L2 CLI measurement via an RRC message or a DCI message. Based on the configuration, the first UE may identify reception timing for an L1/L2 CLI measurement associated with a CLI between the first UE and a second UE. The first UE may perform the L1/L2 CLI measurement associated with the CLI between the first UE and the second UE based on the identified reception timing. Accordingly, based on the described techniques, the L1/L2 inter-UE CLI measurement may be performed.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a UE, including identifying reception timing for an L1/L2 CLI measurement associated with a CLI between the first UE and a second UE; and performing the L1/L2 CLI measurement associated with the CLI between the first UE and the second UE based on the identified reception timing.

Aspect 2 is the method of aspect 1, further including: receiving a configuration associated with one or more resources for the L1/L2 CLI measurement from a first cell via an RRC message or a DCI message.

Aspect 3 is the method of aspect 2, further including: receiving a first DL-RS associated with the first UE; receiving a second DL-RS associated with the second UE; and identifying a time delta between the reception of the first DL-RS and the reception of the second DL-RS, where the reception timing for the L1/L2 CLI measurement is identified based on one or more of a TA of the first UE, the time delta, or downlink timing of the first UE.

Aspect 4 is the method of aspect 3, where each of the first DL-RS or the second DL-RS includes an SSB.

Aspect 5 is the method of any of aspects 3 and 4, where a serving cell of the first UE is the first cell, a serving cell of the second UE is a second cell, the configuration includes an indication of the second cell, the indication of the second cell includes a cell indication of the second cell or a PCI of the second cell, and the method further includes: measuring a plurality of DL-RSs from the second cell; and identifying the second DL-RS from the plurality of DL-RSs based on the measurement of the plurality of DL-RSs, the second DL-RS being associated with a greatest received strength in the plurality of DL-RSs.

Aspect 6 is the method of any of aspects 3 and 4, where a serving cell of the first UE is the first cell, a serving cell of the second UE is the first cell, the second DL-RS corresponds to an SSB associated with a greatest received strength at the second UE, and the configuration includes an indication of the second DL-RS.

Aspect 7 is the method of aspect 2, where a serving cell of the first UE is the first cell, a serving cell of the second UE is the first cell, the configuration includes an indication of an uplink transmission from the second UE, and the method further includes: measuring a time delta based on the uplink transmission from the second UE, and where the reception timing for the L1/L2 CLI measurement is identified based on downlink timing of the first UE and the time delta.

Aspect 8 is the method of aspect 7, where the uplink transmission from the second UE is based on one of a periodic scheduling, a semi-persistent scheduling, or a triggering by the first cell.

Aspect 9 is the method of any of aspects 7 and 8, further including: resetting first reception timing of the first UE to downlink reception timing of the first UE subsequent to performing the L1/L2 CLI measurement.

Aspect 10 is the method of any of aspects 1 to 9, where the DCI message triggers an aperiodic L1/L2 CLI measurement.

Aspect 11 is the method of any of aspects 1 to 10, where the first UE is a victim UE associated with the CLI between the first UE and the second UE, and the second UE is an aggressor UE associated with the CLI between the first UE and the second UE.

Aspect 12 is the method of any of aspects 1 to 10, where the first UE is an aggressor UE associated with the CLI between the first UE and the second UE, the second UE is a victim UE associated with the CLI between the first UE and the second UE, and the method further includes: transmitting, for a first cell, a CLI measurement report based on the L1/L2 CLI measurement, the CLI measurement report to be forwarded to the second UE.

Aspect 13 is the method of aspect 12, where the CLI measurement report includes an indication of a time delta.

Aspect 14 is the method of any of aspects 1 to 13, where the performing the L1/L2 CLI measurement further includes: measuring a reference signal from the second UE based on the identified reception timing, and where the L1/L2 CLI measurement is based on a CLI-RSRP of the reference signal from the second UE.

Aspect 15 is the method of any of aspects 1 to 14, where the L1/L2 CLI measurement is one of a periodic L1/L2 CLI measurement, an aperiodic L1/L2 CLI measurement, or a semi-persistent L1/L2 CLI measurement.

Aspect 16 is a method of wireless communication at a network node, including identifying a configuration associated with one or more resources for an L1/L2 CLI measurement associated with a CLI between a first UE and a second UE; and transmitting, for the first UE, the configuration associated with the one or more resources for the L1/L2 CLI measurement via an RRC message or a DCI message, where the L1/L2 CLI measurement is based on the transmitted configuration.

Aspect 17 is the method of aspect 16, where the network node corresponds to a serving cell of the first UE and of the second UE.

Aspect 18 is the method of aspect 17, where the configuration includes an indication of a DL-RS associated with the second UE.

Aspect 19 is the method of aspect 17, where the configuration includes an indication of an uplink transmission from the second UE.

Aspect 20 is the method of aspect 17, where the uplink transmission from the second UE is based on one of a periodic scheduling, a semi-persistent scheduling, or a triggering by the network node.

Aspect 21 is the method of aspect 16, where the network node corresponds to a serving cell of the first UE, the configuration includes an indication of a second network node, the indication of the second network node includes a cell indication of the second network node or a PCI of the second network node, and the second network node corresponds to a serving cell of the second UE.

Aspect 22 is the method of any of aspects 16 to 21, where the first UE is a victim UE associated with the CLI between the first UE and the second UE, and the second UE is an aggressor UE associated with the CLI between the first UE and the second UE.

Aspect 23 is the method of any of aspects 16 to 21, where the first UE is an aggressor UE associated with the CLI between the first UE and the second UE, the second UE is a victim UE associated with the CLI between the first UE and the second UE, and the method further includes: receiving a CLI measurement report from the first UE based on the L1/L2 CLI measurement, the CLI measurement report to be forwarded to the second UE directly or via a second network node that corresponds to a serving cell of the second UE.

Aspect 24 is the method of aspect 23, where the CLI measurement report includes an indication of a time delta.

Aspect 25 is the method of any of aspects 16 to 24, where the DCI message triggers an aperiodic L1/L2 CLI measurement.

Aspect 26 is the method of any of aspects 16 to 25, where the L1/L2 CLI measurement is one of a periodic L1/L2 CLI measurement, an aperiodic L1/L2 CLI measurement, or a semi-persistent L1/L2 CLI measurement, and the L1/L2 CLI measurement is based on a CLI-RSRP of a reference signal from the second UE.

Aspect 27 is an apparatus for wireless communication including at least one processor coupled to a memory and, based at least in part on information stored in the memory, the at least one processor is configured to implement a method as in any of aspects 1 to 26.

Aspect 28 may be combined with aspect 27 and further includes a transceiver coupled to the at least one processor.

Aspect 29 is an apparatus for wireless communication including means for implementing any of aspects 1 to 26.

Aspect 30 is a non-transitory computer-readable storage medium storing computer executable code, where the code when executed by a processor causes the processor to implement any of aspects 1 to 26.

Various aspects have been described herein. These and other aspects are within the scope of the following claims.

What is claimed is:

1. An apparatus for wireless communication at a first user equipment (UE), comprising:
a memory; and
at least one processor coupled to the memory and, based at least in part on information stored in the memory, the at least one processor is configured to:
identify reception timing for a layer 1 (L1)/layer 2 (L2) cross-link interference (CLI) measurement associated with a CLI between the first UE and a second UE; and
perform the L1/L2 CLI measurement associated with the CLI between the first UE and the second UE based on the identified reception timing.

2. The apparatus of claim 1, the at least one processor being configured to:
receive a configuration associated with one or more resources for the L1/L2 CLI measurement from a first cell via a radio resource control (RRC) message or a downlink control information (DCI) message.

3. The apparatus of claim 2, the at least one processor being further configured to:
receive a first downlink reference signal (DL-RS) associated with the first UE;
receive a second DL-RS associated with the second UE; and
identify a time delta between the reception of the first DL-RS and the reception of the second DL-RS,
wherein the reception timing for the L1/L2 CLI measurement is identified based on one or more of a timing advancement (TA) of the first UE, the time delta, or downlink timing of the first UE.

4. The apparatus of claim 3, wherein each of the first DL-RS or the second DL-RS comprises a synchronization signal block (SSB).

5. The apparatus of claim 3, wherein a serving cell of the first UE is the first cell, a serving cell of the second UE is a second cell, the configuration includes an indication of the second cell, the indication of the second cell includes a cell indication of the second cell or a physical cell identifier (PCI) of the second cell, and the at least one processor is further configured to:
measure a plurality of DL-RSs from the second cell; and
identify the second DL-RS from the plurality of DL-RSs based on the measurement of the plurality of DL-RSs, the second DL-RS being associated with a greatest received strength in the plurality of DL-RSs.

6. The apparatus of claim 3, wherein a serving cell of the first UE is the first cell, a serving cell of the second UE is the first cell, the second DL-RS corresponds to a synchronization signal block (SSB) associated with a greatest received strength at the second UE, and the configuration includes an indication of the second DL-RS.

7. The apparatus of claim 2, wherein a serving cell of the first UE is the first cell, a serving cell of the second UE is the first cell, the configuration includes an indication of an uplink transmission from the second UE, and the at least one processor is further configured to:
measure a time delta based on a reception time at the first UE associated with a downlink transmission from the first cell and a reception time at the first UE associated with the uplink transmission from the second UE,
and wherein the reception timing for the L1/L2 CLI measurement is identified based on downlink timing of the first UE and the time delta.

8. The apparatus of claim 7, wherein the uplink transmission from the second UE is based on one of a periodic scheduling, a semi-persistent scheduling, or a triggering by the first cell.

9. The apparatus of claim 7, the at least one processor being further configured to:
reset first reception timing of the first UE to downlink reception timing of the first UE subsequent to performing the L1/L2 CLI measurement.

10. The apparatus of claim 2, wherein the DCI message triggers an aperiodic L1/L2 CLI measurement.

11. The apparatus of claim 1, wherein the first UE is a victim UE associated with the CLI between the first UE and the second UE, and the second UE is an aggressor UE associated with the CLI between the first UE and the second UE.

12. The apparatus of claim 1, wherein the first UE is an aggressor UE associated with the CLI between the first UE and the second UE, the second UE is a victim UE associated with the CLI between the first UE and the second UE, and the at least one processor is further configured to:
transmit, for a first cell, a CLI measurement report based on the L1/L2 CLI measurement, the CLI measurement report to be forwarded to the second UE.

13. The apparatus of claim 12, wherein the CLI measurement report includes an indication of a time delta.

14. The apparatus of claim 1, wherein to perform the L1/L2 CLI measurement, the at least one processor is further configured to:
measure a reference signal from the second UE based on the identified reception timing, and wherein the L1/L2 CLI measurement is based on a CLI-reference signal received power (CLI-RSRP) of the reference signal from the second UE.

15. The apparatus of claim 1, wherein the L1/L2 CLI measurement is one of a periodic L1/L2 CLI measurement, an aperiodic L1/L2 CLI measurement, or a semi-persistent L1/L2 CLI measurement.

16. The apparatus of claim 1, further comprising a transceiver coupled to the at least one processor, the transceiver being configured to perform the L1/L2 CLI measurement associated with the CLI between the first UE and the second UE.

17. A method of wireless communication at a first user equipment (UE), comprising:
identifying reception timing for a layer 1 (L1)/layer 2 (L2) cross-link interference (CLI) measurement associated with a CLI between the first UE and a second UE; and
performing the L1/L2 CLI measurement associated with the CLI between the first UE and the second UE based on the identified reception timing.

18. An apparatus for wireless communication at a network node, comprising:
a memory; and
at least one processor coupled to the memory and, based at least in part on information stored in the memory, the at least one processor is configured to:
identify a configuration associated with one or more resources for a layer 1 (L1)/layer 2 (L2) cross-link interference (CLI) measurement associated with a CLI between a first user equipment (UE) and a second UE; and
transmit, for the first UE, the configuration associated with the one or more resources for the L1/L2 CLI measurement via a radio resource control (RRC) message or a downlink control information (DCI) message, wherein the L1/L2 CLI measurement is based on the transmitted configuration.

19. The apparatus of claim 18, wherein the network node corresponds to a serving cell of the first UE and of the second UE.

20. The apparatus of claim 19, wherein the configuration includes an indication of a downlink reference signal (DL-RS) associated with the second UE.

21. The apparatus of claim 19, wherein the configuration includes an indication of an uplink transmission from the second UE.

22. The apparatus of claim 21, wherein the uplink transmission from the second UE is based on one of a periodic scheduling, a semi-persistent scheduling, or a triggering by the network node.

23. The apparatus of claim 18, wherein the network node corresponds to a serving cell of the first UE, the configuration includes an indication of a second network node, the indication of the second network node includes a cell indication of the second network node or a physical cell identifier (PCI) of the second network node, and the second network node corresponds to a serving cell of the second UE.

24. The apparatus of claim 18, wherein the first UE is a victim UE associated with the CLI between the first UE and the second UE, and the second UE is an aggressor UE associated with the CLI between the first UE and the second UE.

25. The apparatus of claim 18, wherein the first UE is an aggressor UE associated with the CLI between the first UE and the second UE, the second UE is a victim UE associated with the CLI between the first UE and the second UE, and the at least one processor is further configured to:
receive a CLI measurement report from the first UE based on the L1/L2 CLI measurement, the CLI measurement report to be forwarded to the second UE directly or via a second network node that corresponds to a serving cell of the second UE.

26. The apparatus of claim 25, wherein the CLI measurement report includes an indication of a time delta.

27. The apparatus of claim 18, wherein the DCI message triggers an aperiodic L1/L2 CLI measurement.

28. The apparatus of claim 18, wherein the L1/L2 CLI measurement is one of a periodic L1/L2 CLI measurement, an aperiodic L1/L2 CLI measurement, or a semi-persistent L1/L2 CLI measurement, and the L1/L2 CLI measurement is based on a CLI-reference signal received power (CLI-RSRP) of a reference signal from the second UE.

29. The apparatus of claim 18, further comprising a transceiver coupled to the at least one processor, the transceiver being configured to transmit, for the first UE, the configuration associated with the L1/L2 CLI measurement.

30. A method of wireless communication at a network node, comprising:
identifying a configuration associated with one or more resources for a layer 1 (L1)/layer 2 (L2) cross-link interference (CLI) measurement associated with a CLI between a first user equipment (UE) and a second UE; and
transmitting, for the first UE, the configuration associated with the one or more resources for the L1/L2 CLI measurement via a radio resource control (RRC) message or a downlink control information (DCI) message, wherein the L1/L2 CLI measurement is based on the transmitted configuration.
